(19) United States
(12) Patent Application Publication
(10) Pub. No.: US 2026/0260949 A1
(43) Pub. Date: Sep. 3, 2026

(54) ALL-SOLID-STATE BATTERY

(71) Applicant: SAMSUNG ELECTRO-MECHANICS CO., LTD., Suwon-si, Gyeonggi-do (KR)

(72) Inventors: Kyunglock Kim, Suwon-si, Gyeonggi-do (KR); Youngil Lee, Suwon-si, Gyeonggi-do (KR); Kwangjik Lee, Suwon-si, Gyeonggi-do (KR); Han Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/729,762

(22) PCT Filed: May 30, 2024
(86) PCT No.: PCT/KR2024/007394

§ 371 Date: Jul. 17, 2024

(30) Foreign Application Priority Data
Nov. 6, 2023 (KR) 10-2023-0151474
Mar. 7, 2024 (KR) 10-2024-0032326

(51) Int. Cl. H01M 10/0585; H01M 10/0525; H01M 10/0562

(52) U.S. Cl. CPC H01M 10/0585; H01M 10/0525; H01M 10/0562; H01M 2300/0065

(57) ABSTRACT

An all-solid-state battery including an all-solid-state battery element includes a laminate including a plurality of solid electrolyte layers, a plurality of positive electrode layers, and a plurality of negative electrode layers stacked in a first direction, a first external electrode disposed outside of the laminate and connected to the plurality of positive electrode layers, and a second external electrode disposed outside of the laminate and connected to the plurality of negative electrode layers; and a resin sealing body covering the all-solid-state battery element and exposing a portion of the first external electrode and a portion of the second external electrode. The resin sealing body includes a first resin sealing body and a second resin sealing body, and an elastic modulus of the first resin sealing body is different from an elastic modulus of the second resin sealing body.

### TECHNICAL FIELD

The present disclosure relates to an all-solid-state battery.

### BACKGROUND ART

Recently, as portable electronic devices are required to be miniaturized and used for long periods of time, higher capacity batteries are required, and with the spread of wearable electronic devices, ensuring the safety of batteries is required.

Lithium-ion batteries currently on the market use electrolyte solutions containing flammable organic solvents, so there is a possibility of overheating and fire in the event of a short circuit. Accordingly, an all-solid-state battery using a solid electrolyte instead of an electrolyte solution has been proposed.

All-solid-state batteries can expand as the volume of the electrode active material layer changes during charging and discharging. Inside the expanded all-solid-state battery, an electrode may be damaged or the bonding of an electrode-solid electrolyte interface may be damaged, resulting in poor contact, which may deteriorate battery characteristics, particularly charge-discharge cycle characteristics. Furthermore, cracks may generate in the all-solid-state battery due to a difference in expansion rate of the electrode and the solid electrolyte, causing moisture penetration.

### DISCLOSURE OF INVENTION

### Technical Problem

An aspect of an embodiment attempts to provide an all-solid-state battery that can suppress expansion.

An aspect of an embodiment attempts to provide an all-solid-state battery that can prevent moisture penetration.

However, the problems to be solved by the embodiments of the present invention are not limited to the above-described problems, and can be variously expanded within the scope of the technical spirit of the present invention.

### Solution to Problem

An all-solid-state battery according to an embodiment may include an all-solid-state battery element including a laminate including a plurality of solid electrolyte layers, a plurality of positive electrode layers, and a plurality of negative electrode layers stacked in a first direction, a first external electrode disposed outside of the laminate and connected to the plurality of positive electrode layers, and a second external electrode disposed outside of the laminate and connected to the plurality of negative electrode layers; and a resin sealing body covering the all-solid-state battery element and exposing a portion of the first external electrode and a portion of the second external electrode. The resin sealing body may include a first resin sealing body and a second resin sealing body, and an elastic modulus of the first resin sealing body may be different from an elastic modulus of the second resin sealing body.

In addition, the resin sealing body may expose an end surface of the first external electrode in a second direction and an end surface of the second external electrode in the second direction, and the second direction may intersect with the first direction.

In addition, the first resin sealing body may cover an outer surface of the laminate, and the second resin sealing body may cover the first resin sealing body, at least a portion of a remaining portion excluding the portion of the first external electrode, and at least a portion of a remaining portion excluding the portion of the second external electrode.

In addition, the first external electrode may include a first band portion disposed on an outer surface of the laminate in the first direction, the second external electrode may include a second band portion disposed on the outer surface of the laminate in the first direction, and both ends of the first resin sealing body in the second direction may be in contact with the first band portion and the second band portion, respectively.

In addition, a thickness of the first resin sealing body may be smaller than a thickness of the first band portion and a thickness of the second band portion.

In addition, the first external electrode may include a first band portion disposed on an outer surface of the laminate in the first direction, the second external electrode may include a second band portion disposed on the outer surface of the laminate in the first direction, the first resin sealing body may cover a portion of the first band portion and a portion of the second band portion, and the second resin scaling body may cover a remaining portion of the first band portion and a remaining portion of the second band portion.

In addition, a thickness of the first resin sealing body may be greater than a thickness of the first band portion and greater than a thickness of the second band portion.

In addition, the elastic modulus of the first resin sealing body may be greater than the elastic modulus of the second resin sealing body and the second resin sealing body may cover the first resin sealing body.

In addition, the elastic modulus of the first resin sealing body may be smaller than the elastic modulus of the second resin sealing body and the second resin sealing body may cover the first resin sealing body.

In addition, the first resin sealing body may include a phenolic epoxy resin, a phenol resin, a novolac epoxy resin, an Ortho-Cresol resin, an acryl resin, or a combination thereof.

In addition, the second resin sealing body may include a polyimide resin, a polyimide silicone resin, a silicone resin, a polyamide resin, rubber, a polyurethane resin, or a combination thereof.

An all-solid-state battery according to another embodiment includes all-solid-state battery element including a laminate including a plurality of solid electrolyte layers, a plurality of positive electrode layers, and a plurality of negative electrode layers stacked in a first direction, a first external electrode disposed outside of the laminate and connected to the plurality of positive electrode layers, and a second external electrode disposed outside of the laminate and connected to the plurality of negative electrode layers; and a resin sealing body covering the all-solid-state battery element and exposing a portion of the first external electrode and a portion of the second external electrode. The resin sealing body may include a first resin sealing body, a second resin sealing body, and a third resin sealing body stacked in the first direction.

In addition, an elastic modulus of the first resin sealing body may be greater than an elastic modulus of the second resin sealing body, and an elastic modulus of the third resin sealing body may be greater than the elastic modulus of the second resin sealing body.

In addition, the first external electrode may include a first band portion disposed on an outer surface of the laminate in the first direction, the second external electrode may include a second band portion disposed on the outer surface of the laminate in the first direction, the first resin sealing body may cover the outer surface of the laminate and may be in contact with the first band portion and the second band portion, the second resin sealing body may cover the first resin sealing body and may be in contact with the first band portion and the second band portion, the third resin scaling body may cover the second resin sealing body and expose an end surface of the first external electrode in a second direction and an end surface of the second external electrode in the second direction, and the second direction may intersect with the first direction.

In addition, the first resin sealing body may be disposed between the first band portion and the second band portion, and a thickness of the first resin sealing body may be smaller than a thickness of the first band portion and smaller than a thickness of the second band portion.

In addition, an elastic modulus of the first resin sealing body may be smaller than an elastic modulus of the second resin sealing body, and an elastic modulus of the third resin sealing body may be smaller than the elastic modulus of the second resin sealing body.

In addition, the first external electrode may include a first band portion disposed on an outer surface of the laminate in the first direction, the second external electrode may include a second band portion disposed on the outer surface of the laminate in the first direction, the first resin sealing body may cover the outer surface of the laminate and may be in contact with the first band portion and the second band portion, the second resin sealing body may cover the first resin sealing body and may be in contact with the first band portion and the second band portion, the third resin sealing body may cover the second resin sealing body and expose an end surface of the first external electrode in a second direction and an end surface of the second external electrode in the second direction, and the second direction may intersect with the first direction.

In addition, the first resin sealing body may be disposed between the first band portion and the second band portion, and a thickness of the first resin sealing body may be smaller than a thickness of the first band portion and smaller than a thickness of the second band portion.

An all-solid-state battery according to still another embodiment includes an all-solid-state battery element including a laminate including a plurality of solid electrolyte layers, a plurality of positive electrode layers, and a plurality of negative electrode layers stacked in a first direction, a first external electrode disposed outside of the laminate and connected to the plurality of positive electrode layers, and a second external electrode disposed outside of the laminate and connected to the plurality of negative electrode layers; a substrate including a first electrode pad connected to the first external electrode of the all-solid-state battery element and a second electrode pad connected to the second external electrode of the all-solid-state battery element; a resin sealing body that covers the all-solid-state battery element and is in contact with the substrate; and an outer casing that covers the resin sealing body. The resin sealing body may include a first resin sealing body and a second resin sealing body, the first resin scaling body may cover at least a portion of the all-solid-state battery element, the second resin sealing body may cover the first resin sealing body and is in contact with the substrate, and an elastic modulus of the first resin sealing body may be different from an elastic modulus of the second resin sealing body.

In addition, the elastic modulus of the first resin sealing body may be greater than the elastic modulus of the second resin sealing body.

In addition, the elastic modulus of the first resin sealing body may be smaller than the elastic modulus of the second resin sealing body.

In addition, the resin sealing body may further include a third resin sealing body that covers the second resin sealing body and is in contact with the substrate, and an elastic modulus of the third resin sealing body may be smaller than the elastic modulus of the second resin sealing body.

In addition, the first resin sealing body may cover an outer surface of the laminate, the first external electrode may include a first band portion disposed on the outer surface of the laminate in the first direction, the second external electrode may include a second band portion disposed on the outer surface of the laminate in the first direction, and a thickness of the first resin sealing body may be smaller than a thickness of the first band portion and a thickness of the second band portion.

In addition, the outer casing may include metal or alloy.

In addition, the outer casing may include aluminum (Al), an aluminum (Al) alloy, steel, stainless steel, or a combination thereof.

An all-solid-state battery according to still another embodiment includes an all-solid-state battery element including a laminate comprising a plurality of solid electrolyte layers, a plurality of positive electrode layers, and a plurality of negative electrode layers stacked in a first direction, a first external electrode disposed outside of the laminate and connected to the plurality of positive electrode layers, and a second external electrode disposed outside of the laminate and connected to the plurality of negative electrode layers; and a resin sealing body extending between the first external electrode and the second external electrode and covering a portion of the first external electrode and a portion of the second external electrode. The resin sealing body may include a plurality of layers and may be spaced apart from the plurality of positive electrode layers and the plurality of negative electrode layers.

In addition, the laminate may include a plurality of surfaces, the first external electrode may be disposed on a first surface among the plurality of surfaces to connect to the plurality of positive electrode layers, the second external electrode may be disposed on a second surface among the plurality of surfaces to connect to the plurality of negative electrode layers, the first surface may oppose the second surface, and among the plurality of surfaces, the resin sealing body may cover surfaces other than the first surface and the second surface.

In addition, at least two of the plurality of layers of the resin sealing body may include different materials.

In addition, the at least two of the plurality of layers of the resin sealing body may have different elastic moduli.

In addition, one of the plurality of layers of the resin sealing body may have an elastic modulus greater than an elastic modulus of another of the plurality of layers of the resin sealing body covering the one of the plurality of layers of the resin sealing body.

In addition, the elastic modulus of the one of the plurality of layers of the resin sealing body may be 100 MPa or more, and the another of the plurality of layers of the resin sealing body may be 0.15 MPa or less.

In addition, at least two of the plurality of layers of the resin sealing body may be in contact with the first external electrode and the second external electrode.

An all-solid-state battery according to still another embodiment includes an all-solid-state battery element including a laminate comprising a plurality of solid electrolyte layers, a plurality of positive electrode layers, and a plurality of negative electrode layers stacked in a first direction, a first external electrode disposed outside of the laminate and connected to the plurality of positive electrode layers, and a second external electrode disposed outside of the laminate and connected to the plurality of negative electrode layers; a substrate comprising a first electrode pad connected to the first external electrode of the all-solid-state battery element and a second electrode pad connected to the second external electrode of the all-solid-state battery element; a first resin sealing body that covers the all-solid-state battery element and is disposed between the all-solid-state battery element and the substrate to be in contact with the substrate; a second resin sealing body that covers the first resin sealing body and is in contact with the substrate; and an outer casing that covers the second resin sealing body.

In addition, an elastic modulus of the first resin sealing body may be different from an elastic modulus of the second resin sealing body.

In addition, the elastic modulus of the first resin sealing body may be greater than the elastic modulus of the second resin sealing body.

In addition, the first resin sealing body may cover and be in contact with the first external electrode and second external electrode.

In addition, the second resin sealing body may be spaced apart from the first external electrode and second external electrode.

In addition, the second resin sealing body may be spaced apart from the laminate.

In addition, on the substrate, the first resin scaling body may be disposed between the first electrode pad and the second electrode pad and the second resin sealing body may be disposed in a region outside the first electrode pad and the second electrode.

### Advantageous Effects of Invention

According to the all-solid-state battery according to the embodiment, expansion during charging and discharging of the all-solid-state battery can be suppressed.

According to the all-solid-state battery according to the embodiment, the inflow of moisture can be prevented.

### BRIEF DESCRIPTION OF DRAWINGS

FIG. 1 is a perspective view schematically showing an all-solid-state battery according to an embodiment.

FIG. 2 is a perspective view schematically showing an all-solid-state battery element of FIG. 1.

FIG. 3 is a perspective view schematically showing a laminate of FIG. 1.

FIG. 4 is a cross-sectional view taken along line IV-IV′ of FIG. 1.

FIG. 5A is a partial cross-sectional view schematically showing a positive electrode layer of the all-solid-state battery element of FIG. 2.

FIG. 5B is a partial cross-sectional view schematically showing a negative electrode layer of the all-solid-state battery element of FIG. 2.

FIG. 6 is a schematic cross-sectional view showing an all-solid-state battery according to another embodiment.

FIG. 7 is a schematic cross-sectional view showing an all-solid-state battery according to still another embodiment.

FIG. 8 is a schematic cross-sectional view showing an all-solid-state battery according to yet another embodiment.

FIG. 9 is a schematic cross-sectional view showing an all-solid-state battery according to still yet another embodiment.

FIG. 10 is a schematic cross-sectional view showing an all-solid-state battery according to a further embodiment.

FIG. 11 is a graph showing a result of an initial charge/discharge test performed at a temperature of 25° C. and a humidity of 25% on an all-solid-state battery prepared according to Example.

FIG. 12 is a graph showing a result of an initial charge/discharge test performed at a temperature of 25° C. and a humidity of 25% on an all-solid-state battery prepared according to Comparative Example.

FIG. 13 is a graph showing a result of an initial charge/discharge test performed at a temperature of 25° C. and a humidity of 55% on the all-solid-state battery prepared according to Example.

FIG. 14 is a graph showing a result of an initial charge/discharge test performed at a temperature of 25° C. and a humidity of 55% on the all-solid-state battery prepared according to Comparative Example.

### MODE FOR THE INVENTION

In the following detailed description, only certain embodiments of the present invention have been shown and described, simply by way of illustration. The drawings and description are to be regarded as illustrative in nature and not restrictive. Like reference numerals designate like elements throughout the specification. Further, some constituent elements in the drawings may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the present invention includes all of the modifications, equivalents, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

Throughout the specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Further, throughout the specification, when it is referred to as “on a plane”, it means when a target part is viewed from above, and when it is referred to as “on a cross-section”, it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

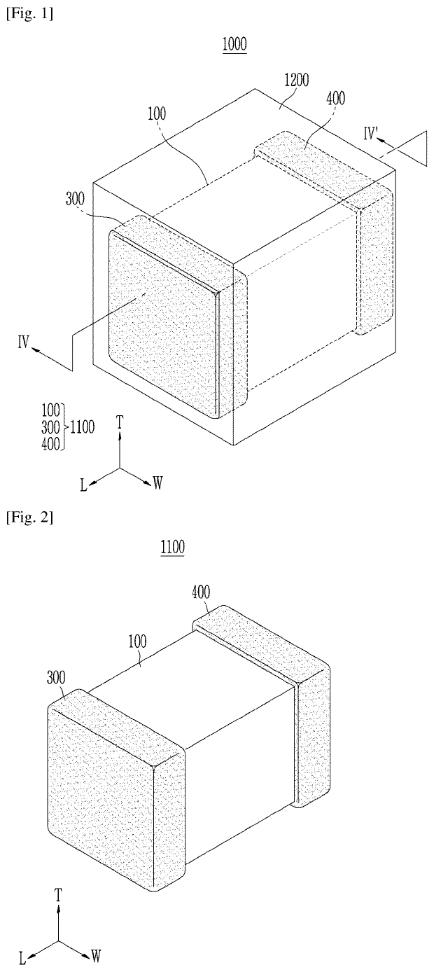

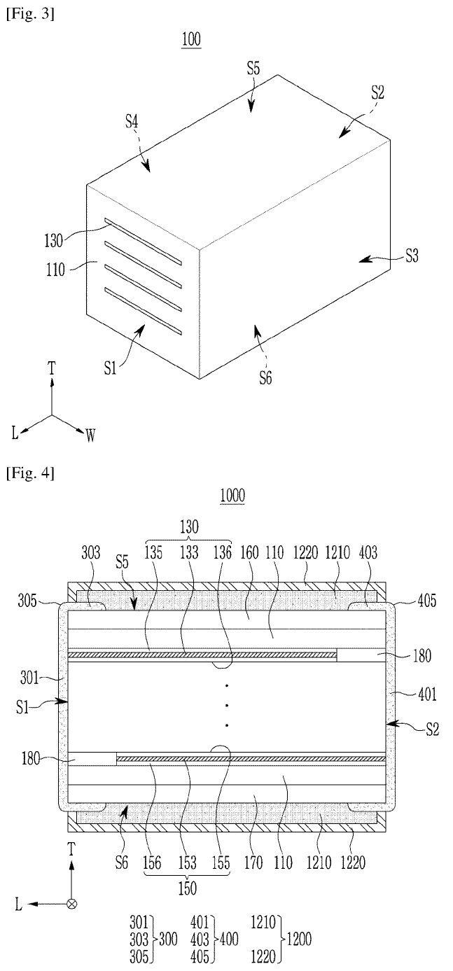

FIG. 1 is a perspective view schematically showing an all-solid-state battery according to an embodiment, FIG. 2 is a perspective view schematically showing an all-solid-state battery element of FIG. 1, FIG. 3 is a perspective view schematically showing a laminate of FIG. 1, and FIG. 4 is a cross-sectional view taken along line IV-IV′ of FIG. 1.

Referring to FIGS. 1, 2, 3, and 4, an all-solid-state battery 1000 according to the present embodiment includes an all-solid-state battery element 1100 and a resin sealing body 1200.

First, when directions are defined in order to clearly describe the present embodiment, an L-axis, a W-axis, and a T-axis shown in the drawings indicate axes representing a length direction, a width direction, and a thickness direction of the all-solid-state battery 1000, respectively.

The thickness direction (T-axis direction) may be a direction perpendicular to a wide surface (main surface) of sheet-shaped components. For example, the thickness direction (T-axis direction) may be used as the same concept as a direction in which components of a laminate 100 are stacked.

The length direction (L-axis direction) is a direction parallel to the wide surface (main surface) of the sheet-shaped components and may be a direction that intersects with (or is orthogonal to) the thickness direction (T-axis direction). For example, the length direction (L-axis direction) may be a direction in which a first external electrode 300 and a second external electrode 400 oppose each other.

The width direction (W-axis direction) is a direction parallel to the wide surface (main surface) of sheet-shaped components and may be a direction that intersects with (or is orthogonal to) the thickness direction (T-axis direction) and the length direction (L-axis direction) at the same time.

The all-solid-state battery element 1100 includes a laminate 100, a first external electrode 300, and a second external electrode 400.

The laminate 100 may have a substantially hexahedral shape, but the present embodiment is not limited thereto. Due to shrinkage during sintering, the laminate 100 may not have a complete hexahedral shape, but may have a substantially hexahedral shape. For example, the laminate 100 has a substantially rectangular parallelepiped shape, but portions corresponding to corners or vertices may have a rounded shape.

In the present embodiment, for convenience of description, surfaces opposing each other in the length direction (L-axis direction) are defined as a first surface S1 and a second surface S2, surfaces opposing each other in the width direction (W-axis direction) and connecting the first surface S1 and the second surface S2 are defined as a third surface S3 and a fourth surface S4, and surfaces opposing each other in the thickness direction (T-axis direction) and connecting the first surface S1 and the second surface S2 are defined as a fifth surface S5 and a sixth surface S6.

Accordingly, a first direction in which the first surface S1 and the second surface S2 oppose each other may be the length direction (L-axis direction), and a second direction and a third direction perpendicular to the first direction and perpendicular to each other may be the thickness direction (T-axis direction) and the width direction (W-axis direction), or the width direction (W-axis direction) and the thickness direction (T-axis direction), respectively.

A length of the laminate 100 may mean, based on an optical microscope or scanning electron microscope (SEM) photograph of a cross section in the length direction (L-axis direction) and the thickness direction (T-axis direction) at a central portion of the laminate 100 in the width direction (W-axis direction), a maximum value among lengths of a plurality of line segments, each of which connects two outermost boundary lines opposing in the length direction (L-axis direction) of the laminate 100 shown in the cross-sectional photograph and is parallel to the length direction (L-axis direction). Note that the length of the laminate 100 may mean a minimum value among lengths of a plurality of line segments, each of which connects two outermost boundary lines opposing in the length direction (L-axis direction) of the laminate 100 shown in the cross-sectional photograph and is parallel to the length direction (L-axis direction). On the other hand, the length of the laminate 100 may mean an arithmetic average value of lengths of at least two line segments among a plurality of line segments, each of which connects two outermost boundary lines opposing in the length direction (L-axis direction) of the laminate 100 shown in the cross-sectional photograph and is parallel to the length direction (L-axis direction).

A thickness of the laminate 100 may mean, based on an optical microscope or scanning electron microscope (SEM) photograph of a cross section in the length direction (L-axis direction) and the thickness direction (T-axis direction) at a central portion of the laminate 100 in the width direction (W-axis direction), a maximum value among lengths of a plurality of line segments, each of which connects two outermost boundary lines opposing in the thickness direction (T-axis direction) of the laminate 100 shown in the cross-sectional photograph and is parallel to the thickness direction (T-axis direction). Note that the thickness of the laminate 100 may mean a minimum value among lengths of a plurality of line segments, each of which connects two outermost boundary lines opposing in the thickness direction (T-axis direction) of the laminate 100 shown in the cross-sectional photograph and is parallel to the thickness direction (T-axis direction). On the other hand, the thickness of the laminate 100 may mean an arithmetic average value of lengths of at least two line segments among a plurality of line segments, each of which connects two outermost boundary lines opposing in the thickness direction (T-axis thickness) of the laminate 100 shown in the cross-sectional photograph and is parallel to the thickness direction (T-axis direction).

A width of the laminate 100 may mean, based on an optical microscope or scanning electron microscope (SEM) photograph of a cross section in the length direction (L-axis direction) and the width direction (W-axis direction) at a central portion of the laminate 100 in the thickness direction (T-axis direction), a maximum value among lengths of a plurality of line segments, each of which connects two outermost boundary lines opposing in the width direction (W-axis direction) of the laminate 100 shown in the cross-sectional photograph and is parallel to the width direction (W-axis direction). Note that the width of the laminate 100 may mean a minimum value among lengths of a plurality of line segments, each of which connects two outermost boundary lines opposing in the width direction (W-axis direction) of the laminate 100 shown in the cross-sectional photograph and is parallel to the width direction (W-axis direction). On the other hand, the width of the laminate 100 may mean an arithmetic average value of lengths of at least two line segments among a plurality of line segments, each of which connects two outermost boundary lines opposing in the width direction (W-axis thickness) of the laminate 100 shown in the cross-sectional photograph and is parallel to the width direction (W-axis direction).

The laminate 100 may include a solid electrolyte layer 110, a positive electrode layer 130, a negative electrode layer 150, an upper protective layer 160, a lower protective layer 170, and a margin portion 180.

The solid electrolyte layer 110, the positive electrode layer 130, and the negative electrode layer 150 may each be plural. The positive electrode layer 130 and the negative electrode layer 150 may be alternately stacked in the thickness direction (T-axis direction) with the solid electrolyte layer 110 interposed therebetween. Such a laminated structure may repeat within the laminate 100, and the electrode layer closest to the fifth surface S5 of the laminate 100 may be the positive electrode layer 130 or the negative electrode layer 150, and the electrode layer closest to the sixth surface S6 may be the negative electrode layer 150 or the positive electrode layer 130.

The positive electrode layer 130 may be disposed on one surface of the solid electrolyte layer 110 and the negative electrode layer 150 may be disposed on the other surface of the solid electrolyte layer 110.

The solid electrolyte layer 110 includes a solid electrolyte. The solid electrolyte may serve as a passageway for lithium (Li) ions.

The solid electrolyte included in the solid electrolyte layer 110 may include a glass-ceramic-based electrolyte containing lithium halide (LiX wherein X is a halogen element such as F, Br, Cl, I, or the like). The glass-ceramic (or crystallization glass) refers to a crystallographic mixture of amorphous and crystalline materials from which peaks and halos are observed in X-ray diffraction, electron beam diffraction, or the like. Therefore, the glass-ceramic-based electrolyte is an electrolyte that has undergone partial crystallization through sintering and in which amorphous and crystalline materials are mixed.

The glass-ceramic-based electrolyte may include a mixture of an amorphous material and two or more types of crystalline materials. In addition, the crystalline material included in the glass-ceramic-based electrolyte may include a lithium compound crystalline phase containing lithium.

When the glass-ceramic-based electrolyte is included in the solid electrolyte layer 110, sufficient densification is achieved after sintering, whereby it is possible to realize high ionic conductivity.

The glass-ceramic-based electrolyte may include at least one selected from the group consisting of lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). As a specific example, the glass-ceramic-based electrolyte may include Li₂O—B₂O₃—SiO₂—P₂O₅—GeO₂—LiCl.

Alternatively, the solid electrolyte included in the solid electrolyte layer 110 may include a lithium-borosilicate-based electrolyte (hereinafter, also referred to as an LBSO-based electrolyte). The LBSO-based electrolyte is a glass-state electrolyte, and glass refers to a crystallographically amorphous material from which halos are observed in X-ray diffraction, electron beam diffraction, etc.

When the LBSO-based electrolyte is included in the solid electrolyte layer 110, it is possible to keep the amorphous state during sintering while lowering the sintering temperature. Therefore, there is an advantage that it is possible to realize high ionic conductivity, and reactivity with the electrode is not high. The LBSO-based electrolyte may include lithium (Li), boron (B), silicon (Si), aluminum (Al), phosphorus (P), germanium (Ge), and sulfur (S).

Alternatively, the solid electrolyte included in the solid electrolyte layer 110 may be one or more types selected from the group consisting of a Garnet-type, Na super ionic conductor (NASICON)-type, a lithium super ionic conductor (LISICON)-type, a Perovskite-type, and a lithium phosphorus oxynitride (LiPON)-type.

In a region where the margin portion 180 is disposed, which will be described later, a material having low ionic conductivity and low electrical conductivity, that is, an insulating material, may be present, or a material having ionic conductivity (or electrical conductivity) similar to the ionic conductivity (or electrical conductivity) of the solid electrolyte may be present. For example, when a material having ionic conductivity (or electrical conductivity) similar to the ionic conductivity (or electrical conductivity) of the solid electrolyte is present in the area, the material may be a material that is identical to or different from the solid electrolyte in other regions.

In another example, a material having ionic conductivity (or electrical conductivity) similar to the ionic conductivity (or electrical conductivity) of the solid electrolyte and an insulating material may coexist in the region.

The Garnet-type solid electrolyte may refer to lithium-lanthanum zirconium-oxide (LLZO) expressed as LiₐLa_{b}Zr_{c}O₁₂ such as Li₇La₃Zr₂O₁₂, and the NASICON-type solid electrolyte may include lithium-aluminum-titanium-phosphate (LATP) of Li₁₊ₓAlₓTi₂₋ₓ(PO₄)₃ (wherein 0<x<1) produced by introducing Ti to Li₁₊ₓAlₓM₂₋ₓ(PO₄)₃(LAMP) (wherein 0<x<2, M is Zr, Ti, or Ge)-type compound, lithium-aluminum-germanium-phosphate (LAGP) represented by Li₁₊ₓAlₓGe₂₋ₓ(PO₄)₃ (wherein 0<x<1), such as Li_{1.3}Al_{0.3}Ge_{1.7}(PO₄)₃ containing an excessive amount of lithium, and/or lithium-zirconium-phosphate (LZP) of LiZr₂(PO₄)₃.

In addition, the LISICON-type solid electrolyte may include solid solution oxide represented by xLi₃AO₄—(1−x)Li₄BO₄ (wherein A is P, As, V, etc., and B is Si, Ge, Ti, etc.), such as Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08} O_{11.92} and the like, and solid solution sulfide represented by Li₄₋ₓM_{1-y}M′_{y}S₄ (wherein M is Si or Ge and M′ is P, Al, Zn, or Ga), such as Li₂S—P₂S₅, Li₂S—SiS₂, Li₂S—SiS₂—P₂S₅, Li₂ S—GeS₂ and the like.

Further, the Perovskite-type solid electrolyte may include lithium-lanthanum-tit anium-oxide (LLTO) represented by Li₃ₓLa_{2/3-x}□_{1/3-2x}TiO₃ (wherein 0<x<0.16, and □ is vacancy), such as Li_{1/8}La_{5/8}TiO₃, and the LiPON-type solid electrolyte may include nitride such as lithium phosphorous oxynitride such as Li_{2.8}PO_{3.3}N_{0.46}.

The positive electrode layer 130 may be exposed outside of the laminate 100 from the first surface S1 of the laminate 100, and may be connected to the first external electrode 300.

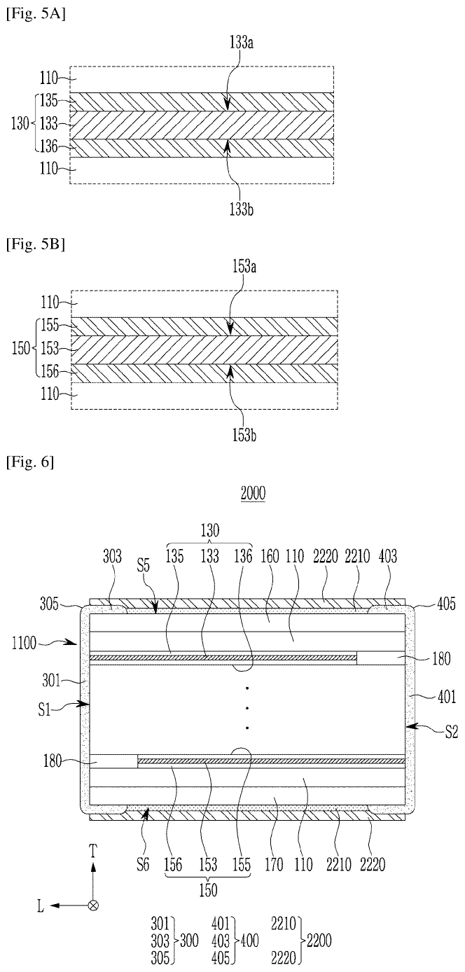

Referring to FIGS. 4 and 5A, the positive electrode layer 130 may include a positive electrode current collector 133, a first positive electrode active material layer 135, and a second positive electrode active material layer 136.

For example, the positive electrode current collector 133 may be made of a plate-shape member or a thin member. As another example, the positive electrode current collector 133 may be a porous body having a reticulate shape, a mesh shape, or the like.

The positive electrode current collector 133 may include a first surface 133a and a second surface 133b. The first surface 133a and the second surface 133b oppose each other in the thickness direction (T-axis direction).

For example, the positive electrode current collector 133 may include, but not limited to, a porous metal plate made of stainless steel, nickel (Ni), copper (Cu), tin (Sn), aluminum (Al), or an alloy thereof.

In addition, the positive electrode current collector 133 may be coated with an oxidation-resistant metal or alloy film in order to prevent oxidation.

The positive electrode current collector 133 may also include a carbon-based plate-shaped, thin, or linear member. The positive electrode current collector 133 may include a conductive carbon material. The conductive carbon material may include graphite, conductive fiber such as carbon nanotube (CNT) or vapor grown carbon fiber (VGCF), or conductive carbon such as carbon black.

Meanwhile, the positive electrode current collector may also include one or more types of solid electrolytes.

The first positive electrode active material layer 135 and the second positive electrode active material layer 136 may include positive electrode active materials, and may be disposed on a surface of the positive electrode current collector 133. The first positive electrode active material layer 135 and the second positive electrode active material layer 136 may be formed by printing a positive electrode active material on one or both surfaces of the positive electrode current collector 133. However, the method of forming the positive electrode active material layer is limited thereto.

The positive electrode active material included in the positive electrode active material layers 135 and 136 may comprise a material containing lithium (Li) ions. The positive electrode active material may reversibly intercalate and deintercalate lithium ions. That is, the positive electrode active material may contain lithium ions and serve to provide the lithium ions to the negative electrode when the all-solid-state battery is being charged. The positive electrode active material may affect the capacity and output of the all-solid-state battery.

For example, the positive electrode active material may include at least one selected from the group consisting of compounds represented by the following formulae: LiₐA_{1-b}M_{b}D₂ (where, 0.90≤a≤1.8, 0≤b≤0.5); LiₐE_{1-b}M_{b}O_{2-c}D_{c} (where 0.90≤a≤1.8, 0≤b≤0.5, 0≤c≤0.05); LiE_{2-b}M_{b}O_{4-c}D_{c} (where 0≤b≤0.5, 0≤c≤0.05); LiₐNi_{1-b-c}Co_{b}M_{c}D_{α} (where 0.90≤a≤1.8, 0≤b≤0.5, 0≤c≤0.05, 0<α≤2); LiₐNi_{1-b-c}Co_{b}M_{c}O_{2-α}X_{α} (where 0.90≤a≤1.8, 0≤b≤0.5, 0≤c≤0.05, 0<a≤2); LiₐNi_{1-b-c}Co_{b}M_{c}O_{2-α}X_{α} (where 0.90≤a≤1.8, 0≤b≤0.5, 0≤c≤0.05, 0<α<2); LiₐNi_{1-b-c}Mn_{b}M_{c}D_{α} (where 0.90≤a≤1.8, 0≤b≤0.5, 0≤c≤0.05, 0<a≤2); LiₐNi_{1-b-c}Mn_{b}M_{c}O_{2-α}D_{α} (where, 0.90≤a≤1.8, 0≤b≤0.5, 0≤c≤0.05, 0<α<2); LiₐNi_{1-b-c}Mn_{b}M_{c}O_{2-α}X₂ (where, 0.90≤a≤1.8, 0≤b≤0.5, 0≤c≤0.05, 0<α<2); LiₐNi_{b}E_{c}G_{d}O₂ (where, 0.90≤a≤1.8, 0≤b≤0.9, 0≤c≤0.5, 0.001≤d≤0.1); LiₐNi_{b}Co_{c}Mn_{d}GₑO₂ (where,0.90≤a≤1.8, 0≤b≤0.9, 0≤c≤0.5, 0≤d≤0.5, 0.001≤e≤0.1); LiₐNiG_{b}O₂ (where, 0.90≤a≤1.8, 0.001≤b≤0.1); LiₐCoG_{b}O₂ (where, 0.90≤a≤1.8, 0.001≤b≤0.1); LiₐMnG_{b}O2 (where, 0.90≤a≤1.8, 0.001≤b≤0.1); LiₐMn₂G_{b}O₄ (where, 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (where, 0≤f≤2); and LiFePO₄. In the above chemical formulas, A represents Ni, Co, or Mn; M represents Al, Ni, Co, Mn, Cr, Fe, Mg, Sr, V, Nb, Ti or a rare-earth element; D represents O, F, S, or P; E represents Co or Mn; X represents F, S, or P; G represents Al, Cr, Mn, Fe, Mg, La, Ce, Sr, or V; Q represents Ti, Mo or Mn; R represents Cr, V, Fe, Se, or Y; and J represents V, Cr, Mn, Co, Ni, or Cu.

The positive electrode active material may also include LiCoO₂, LiMnₓO₂ₓ (where, x is 1 or 2), LiNi₁₋ₓMnₓO₂ₓ (where, 0<x<1), LiNi_{1-x-y}CoₓMn_{y}O₂ (where, 0≤x≤0.5 and 0≤y≤0.5), LiFePO₄, TiS₂, FeS₂, TiS₃, or FeS₃, but is not limited thereto.

The positive electrode active material may optionally include a conductive material and a binder. However, because an organic substance such as a binder decomposes during sintering process, the organic material may not remain on the positive electrode active material layer of the obtained positive electrode current collector.

The conductive material is not particularly limited as long as it has conductivity without causing a chemical change in the all-solid-state battery 1000. For example, graphite such as natural graphite or artificial graphite; carbon-based materials such as carbon black, acetylene black, Ketjenblack®, channel black, furnace black, lamp black, and thermal black; conductive fibers such as carbon fibers, metal fibers, etc. ; carbon fluoride; metal components such as lithium (Li), tin (Sn), aluminum (Al), nickel (Ni), copper (Cu), etc., oxides thereof, nitrides thereof, or fluorides thereof; conductive whiskers such as zinc oxide and potassium titanate; conductive metal oxide such as titanium oxide; conductive materials such as polyphenylene derivatives, etc. may be used.

The binder may be used to improve the bonding strength of the active material, the conductive material, or the like. The binder may include, but not limited to, at least one selected from the group consisting of polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber (SBR), fluorine rubber, various copolymers, and the like.

Meanwhile, the positive electrode layer 130 may further contain a solid electrolyte component. The solid electrolyte component may contain one or more of the above-mentioned components, and may serve as an ionic conduction channel in the positive electrode layer. Therefore, it is possible to reduce interface resistance.

The negative electrode layer 150 may be exposed outside of the laminate 100 from the second surface S2 of the laminate 100, and may be connected to the second external electrode 400.

Referring to FIGS. 4 and 5B, the negative electrode layer 150 may include a negative electrode current collector 153, a first negative electrode active material layer 155, and a second negative electrode active material layer 156.

For example, the negative electrode current collector 153 may include a plate-shaped member or a thin member. As another example, the negative electrode current collector 153 may include a porous body having a reticulate shape, a mesh shape, or the like.

The negative electrode current collector 153 may include a first surface 153a and a second surface 153b. The first surface 153a and the second surface 153b oppose each other in the thickness direction (T-axis direction).

For example, the negative electrode current collector 153 may include, but not limited to, a porous metal plate made of stainless steel, nickel (Ni), copper (Cu), tin (Sn), aluminum (Al), or an alloy thereof.

In addition, the negative electrode current collector 153 may be coated with an oxidation-resistant metal or alloy film to prevent oxidation.

The negative electrode current collector 153, like the positive electrode current collector 133, may include a conductive carbon-based material, and may include one or more types of solid electrolytes. The negative electrode current collector 153 may be identical to the negative electrode active material layers 155 and 156.

The first negative electrode active material layer 155 and the second negative electrode active material layer 156 may include negative electrode active materials and be disposed on a surface of the negative electrode current collector 153. The first negative electrode active material layer 155 and the second negative electrode active material layer 156 may be formed by printing a negative electrode active material on one or both surfaces of the negative electrode current collector 153. However, the method of forming the negative electrode active material layer is not limited thereto.

The negative electrode active material in the negative electrode active material layers 155 and 156 may store the lithium ions that have moved from the positive electrode and release the lithium ions when the all-solid-state battery is discharged, thereby generating electrical energy. A carbon-based material, silicon, a silicon oxide, a silicon-based alloy, a silicon-carbon-based material composite, tin, a tin-based alloy, a tin-carbon composite, a metal oxide, or a combination thereof may be used as the negative electrode active material. The negative electrode active material may contain a lithium metal and/or a lithium metal alloy.

The lithium metal alloy may contain lithium, and metal/metalloid capable of making an alloy with lithium. For example, the metal/metalloid capable of making an alloy with lithium may include Si, Sn, Al, Ge, Pb, Bi, Sb, and Si-AM alloy (wherein AM is an alkali metal, an alkaline earth metal, an element in group 13 to 16, a transition metal, a rare-earth element, or a combination thereof, and does not include Si), Sn-AM alloys (wherein AM is an alkali metal, an alkaline earth metal, an element in group 13 to 16, a transition metal, a transition metal oxide such as lithium titanium oxide (Li₄Ti₅O₁₂), a rare-earth element, or combinations thereof, and does not include Sn), MnOₓ (wherein 0<x≤2), and the like.

The element AM may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or combinations thereof.

In addition, the oxide of the metal/metalloid capable of making an alloy with lithium may include lithium titanium oxide, vanadium oxide, lithium vanadium oxide, SnO₂, SiOₓ (wherein 0<x<2), or the like. For example, the negative electrode active material may include one or more elements selected from the group consisting of the elements in group 13 to 16 of the periodic table of elements. For example, the negative electrode active material may contain one or more elements selected from the group consisting of Si, Ge, and Sn.

The carbon-based material may include crystalline carbon, amorphous carbon, or a mixture thereof. The crystalline carbon may be graphite such as natural graphite or artificial graphite that is in a shapeless, disc-shaped, flake-shaped, globular, or fibrous form. In addition, the amorphous carbon may include, but not limited to, soft carbon (low-temperature calcined carbon), hard carbon, mesophase pitch carbide, calcined cokes, graphene, carbon black, fullerene soot, carbon nanotube, carbon fiber, and the like.

The silicon may include at least one selected from the group consisting of Si, SiOₓ (wherein 0<x<2, for example, 0.5 to 1.5), Sn, SnO₂, or silicon-containing metal alloy, and mixtures thereof. For example, the silicon-containing metal alloy may include silicon, and one or more of Al, Sn, Ag, Fe, Bi, Mg, Zn, in, Ge, Pb, or Ti.

The negative electrode active material may optionally include a conductive material and a binder.

The conductive material is not particularly limited as long as it has conductivity without causing a chemical change in the all-solid-state battery 1000. For example, graphite such as natural graphite or artificial graphite; carbon-based materials such as carbon black, acetylene black, Ketjenblack®, channel black, furnace black, lamp black, and thermal black; conductive fibers such as carbon fibers, metal fibers, etc. ; carbon fluoride; metal components such as lithium (Li), tin (Sn), aluminum (Al), nickel (Ni), copper (Cu), etc., oxides thereof, nitrides thereof, or fluorides thereof; conductive whiskers such as zinc oxide and potassium titanate; conductive metal oxide such as titanium oxide; conductive materials such as polyphenylene derivatives, etc. may be used.

The binder may be used to improve the bonding strength of the active material, the conductive material, or the like. The binder may include, but not limited to, at least one selected from the group consisting of polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber (SBR), fluorine rubber, various copolymers, and the like.

Meanwhile, the negative electrode layer 150 may further contain a solid electrolyte component. The solid electrolyte component may contain one or more of the above-mentioned components, and may serve as an ionic conduction channel in the negative electrode layer. Therefore, it is possible to reduce interface resistance.

The upper protective layer 160 and the lower protective layer 170 may be outermost layers respectively disposed on the fifth surface S5 and sixth surface S6 of the laminate 100. That is, the upper protective layer 160 may be the outermost layer on the fifth surface S5 of the laminate 100, and the lower protective layer 170 may be the outermost layer on the sixth surface S6 of the laminate 100. The upper protective layer 160 and lower protective layer 170 may improve reliability of moisture resistance by preventing moisture penetration and prevent damage caused by physical and chemical stress.

The upper protective layer 160 and the lower protective layer 170 may be insulating layers including an insulating material, i.e., a material that is not electrically (ionically) conductive.

The upper protective layer 160 and the lower protective layer 170 may include, but not limited to, at least one selected from the group consisting of ceramic materials, e.g., alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides and/or nitrides thereof, and any other suitable ceramic material. In addition, the upper protective layer 160 and the lower protective layer 170 may optionally include the above-mentioned solid electrolyte and may include one or more types of solid electrolytes. However, the present disclosure is not limited thereto.

For example, the margin portion 180 may be disposed on the solid electrolyte layer 110 in a region excluding the region where the positive electrode layer 130 or the negative electrode layer 150 is disposed. If the positive electrode layer 130 is disposed on the solid electrolyte layer 110, the margin portion 180 may be disposed in an area excluding the area where the positive electrode layer 130 is disposed. Similarly, if the negative electrode layer 150 is disposed on the solid electrolyte layer 110, the margin portion 180 may be disposed in the region excluding the region where the negative electrode layer 150 is disposed.

Referring to FIG. 4, the margin portion 180 may comprise a portion of the first surface S1 and a portion of the second surface S2 of the laminate 100. Meanwhile, although not shown, the margin portion 180 may also comprise a portion of the third surface S3 and a portion of the fourth surface S4 of the laminate 100.

The margin portion 180 may be disposed to compensate for a level difference between the solid electrolyte layer 110 and the positive electrode layer 130 and a level difference between the solid electrolyte layer 110 and the negative electrode layer 150. For example, the margin portion 180 may be disposed on the same surface as the positive electrode layer 130 and the negative electrode layer 150. The margin portion 180 may compensate for a level difference between the solid electrolyte layer 110 and the positive electrode layer 130 or a level difference between the solid electrolyte layer 110 and the negative electrode layer 150. This increases the density between the solid electrolyte layer 110 and the electrode layers, which may prevent interlayer delamination or warping caused by sintering during a process of manufacturing the all-solid-state battery.

Meanwhile, the margin portion 180 may include a material that is resistant to moisture and has low lithium (Li) ion conductivity. In this case, the margin portion 180 may protect the active material layers 135, 136, 155, and 156 from moisture infiltration or lithium (Li) ion leakage. For example, the margin portion 180 may include an insulating material or an electrolyte material, and may include a material with an ionic conductivity of 1.0×10⁻¹⁰ S/cm or less.

The margin portion 180 may include an insulating material, i.e., a material that does not have electrically (ionically) conductive.

The margin portion 180 may include, but not limited to, at least one selected from the group consisting of ceramic materials, e.g., alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides thereof and/or nitrides thereof, or any other suitable ceramic material.

Meanwhile, the margin portion 180 may include a solid electrolyte that is identical to or different from the solid electrolyte included in the above-described solid electrolyte layer, and may include one or more types of solid electrolytes. However, the present disclosure is not limited thereto.

In addition, in the margin portion 180, a material having a low ionic conductivity and electrical conductivity, i.e., an insulating material, may be present, and a material having ionic conductivity (or electrical conductivity) similar to the ionic conductivity (or electrical conductivity) of the solid electrolyte may be present. For example, when a material having ionic conductivity (or electrical conductivity) similar to the ionic conductivity (or electrical conductivity) of the solid electrolyte is present in the margin portion, that material may be a material identical to or different from the solid electrolyte in other regions. As another example, a material having ionic conductivity (or electrical conductivity) similar to the ionic conductivity (or electrical conductivity) of the solid electrolyte and an insulating material may coexist in the margin portion.

The first external electrode 300 and the second external electrode 400 are disposed on the outside of the laminate 100.

The first external electrode 300 is connected to the positive electrode layer 130 on the first surface S1 of the laminate 100.

For example, the first external electrode 300 may extend onto the third surface S3, the fourth surface S4, the fifth surface S5, and the sixth surface S6 of the laminate 100 to partially cover the respective surfaces.

The second external electrode 400 is connected to the negative electrode layer 150 on the second surface S2 of the laminate 100.

For example, the second external electrode 400 may extend onto the third surface S3, the fourth surface S4, the fifth surface S5, and the sixth surface S6 of the laminate 100 to partially cover the respective surfaces.

Meanwhile, in some embodiments, the first external electrode 300 and the second external electrode 400 may extend onto either the fifth surface S5 or the sixth surface S6 to partially cover the corresponding surface.

The first external electrode 300 may include a first connection portion 301, a first band portion 303, and a first edge portion 305.

The first connection portion 301 covers the first surface S1 of the laminate 100 and is electrically connected to the positive electrode layer 130.

In some embodiments, the first connection portion 301 may cover a portion of the first surface S1 of the laminate 100.

The first band portion 303 extends from the first connection portion 301 to cover a portion of the fifth surface S5 and a portion of the sixth surface S6 of the laminate 100. The first band portion 303 may allow the first external electrode 300 to be more strongly adhered to the laminate 100.

The first edge portion 305 may be a portion that connects the first connection portion 301 and the first band portion 303.

The second external electrode 400 may include a second connection portion 401, a second band portion 403, and a second edge portion 405, respectively.

The second connection portion 401 covers the second surface S2 of the laminate 100 and is electrically connected to the negative electrode layer 150.

In some embodiments, the second connection portion 401 may cover a portion of the second surface S2 of the laminate 100.

The second band portion 403 extends from the second connection portion 401 to cover a portion of the fifth surface S5 and a portion of the sixth surface S6 of the laminate 100. The second band portion 403 may allow the second external electrode 400 to be more strongly adhered to the laminate 100.

The second edge portion 405 may be a portion that connects the second connection portion 401 and the second band portion 403.

Based on an optical microscope or scanning electron microscope (SEM) photograph of a cross section taken along the length direction (L-axis direction) and the thickness direction (T-axis direction) at a central portion of the all-solid-state battery 1000 in the width direction (W-axis direction), in the all-solid-state battery 1000 shown in the above cross-sectional photograph, the first connection portion 301 and the second connection portion 401 may have a shape substantially parallel to the thickness direction (T-axis direction), the first band portion 303 and the second band portion 403 may have a shape substantially parallel to the length direction (L-axis direction), and the first edge portion 305 and the second edge portion 405 may have a curved line shape. The above-described curved line shape may be a curved line shape having a tangent whose slope changes from a direction parallel to the thickness direction (T-axis direction) to a direction parallel to the length direction (L-axis direction) (or in opposite directions).

For example, the first external electrode 300 and the second external electrode 400 may be fired electrodes including conductive metal and glass. As another example, the first external electrode 300 and the second external electrode 400 may be resin-based electrodes including conductive metal and base resin. In this case, the base resin may be an epoxy resin.

For example, the first external electrode 300 and the second external electrode 400 may be made by applying paste containing a conductive metal to each of the first surface S1 and the second surface S2 of the laminate 100, or may be made by transferring dry films produced by drying conductive paste to the laminate 100 and then sintering it. However, the method of forming the first external electrode 300 and the second external electrode 400 is not limited thereto. The conductive metal may include, for example, one or more of copper (Cu), nickel (Ni), tin (Sn), palladium (Pd), platinum (Pt), gold (Au), silver (Ag), tungsten (W), titanium (Ti), lead (Pb), and alloys thereof, but is not limited thereto.

Meanwhile, by forming a plating layer on the first external electrode 300 and the second external electrode 400, respectively, the mounting characteristics of the external electrodes may also be improved. The plating layer may include at least one selected from the group consisting of copper (Cu), nickel (Ni), tin (Sn), palladium (Pd), platinum (Pt), gold (Au), silver (Ag), tungsten (W), titanium (Ti), lead (Pb), and an alloy thereof, but the present disclosure is not limited thereto. The plating layer may be formed to have one or more layers.

The resin sealing body 1200 may partially cover the all-solid-state battery element 1100. The resin sealing body 1200 may expose a portion of the first external electrode 300 and a portion of the second external electrode 400 of the all-solid-state battery element 1100.

The resin sealing body 1200 may include a first resin sealing body 1210 and a second resin sealing body 1220.

The first resin sealing body 1210 may be a harder material than the second resin sealing body 1220. That is, the first resin sealing body 1210 may be more resistant to elastic deformation than the second resin sealing body 1220. Accordingly, the elastic modulus (or Young's modulus) of the first resin sealing body 1210 may be greater than the elastic modulus of the second resin sealing body 1220.

The first resin sealing body 1210 may cover at least a portion of an outer surface of the laminate 100.

For example, the first resin sealing body 1210 may cover a portion of the third surface S3, a portion of the fourth surface S4, a portion of the fifth surface S5, and a portion of the sixth surface S6 of the laminate 100.

Additionally, the first resin sealing body 1210 may cover a portion of the first band portion 303 and a portion of the second band portion 403.

An area from an end of the first band portion 303 close to a central portion of the laminate 100 in the length direction (L-axis direction) to a point spaced apart from the first edge portion 305 may be covered by the first resin sealing body 1210. That is, the first resin sealing body 1210 may not be disposed on the first edge portion 305 of the first external electrode 300. In addition, an area from an end of the second band portion 403 close to the central portion of the laminate 100 in the length direction (L-axis direction) to a point spaced apart from the second edge portion 405 may be covered by the first resin sealing body 1210. That is, the first resin sealing body 1210 may not be disposed on the second edge portion 405 of the second external electrode 400.

In this way, the first resin sealing body 1210 may cover the outer surface of the laminate 100 exposed by the first band portion 303 and the second band portion 403 and may also cover a portion of the first band portion 303 and a portion of the second band portion 403.

The first resin sealing body 1210 may include a phenolic epoxy resin, a phenol resin, a novolac epoxy resin, an Ortho-Cresol resin, an acryl resin, or a combination thereof, but the present embodiment is not limited thereto.

The elastic modulus of the first resin sealing body 1210 may be 100 MPa or more and 300 MPa or less. If the elastic modulus of the first resin sealing body 1210 is less than 100 MPa, it may be difficult to effectively prevent volume expansion of the all-solid-state battery, and if the elastic modulus exceeds 300 MPa, brittleness may increase, making the all-solid-state battery vulnerable to impact.

The elastic modulus of the first resin sealing body 1210 may be measured by a well-known method in the art. For example, the first resin sealing body may be peeled off from the all-solid-state battery, a sample with dimensions of 10 mm×2 mm×4 mm may be cut, and the elastic modulus may be measured while increasing the temperature from 30° C. at a rate of 3° C./minute by using a dynamic mechanical analyzer (DMA) (RSA-G2 available from TA Instruments).

A tensile strength of the first resin sealing body 1210 may be 82 MPa or more and 85 MPa or less. If the tensile strength of the first resin sealing body 1210 is less than 82 MPa, brittleness may increase, making the all-solid-state battery vulnerable to impact, and if the tensile strength exceeds 85 MPa, the resistance to elastic deformation will be lowered, making it difficult to prevent volume expansion of the all-solid-state battery.

The tensile strength of the first resin sealing body 1210 may be measured by a well-known method in the art. For example, the first resin sealing body may be peeled off from the all-solid-state battery, a sample with dimensions of 10 mm×2 mm×4 mm may be cut, and the tensile strength may be measured while increasing the temperature from 30° C. at a rate of 3° C./minute by using a dynamic mechanical analyzer (DMA) (RSA-G2 available from TA Instruments).

A thickness of the first resin sealing body 1210 may be 1 μm or more and 1 mm or less. If the thickness of the first resin scaling body 1210 is less than 1 μm, it may be difficult to prevent volume expansion of the all-solid-state battery, and if the thickness exceeds 1 mm, the overall packaging thickness of the all-solid-state battery becomes larger than necessary, which may be disadvantageous in terms of energy density.

Meanwhile, the thickness of the first resin sealing body 1210 may be 10 μm or more and 500 μm or less.

Additionally, the thickness of the first resin sealing body 1210 may be greater than a thickness of the first band portion 303, and the thickness of the first resin sealing body 1210 may be greater than a thickness of the second band portion 403.

Here, the thickness of the first resin sealing body and the thickness of the band portion are measured based on a scanning electron microscope (SEM) photograph at 10,000 magnification of a cross section taken along the length direction (L-axis direction) and the thickness direction (T-axis direction) at the central portion of the all-solid-state battery 1000 in the width direction (W-axis direction). The thickness of the first resin sealing body may be a maximum value of lengths of line segments parallel to the thickness direction (T-axis direction) and connecting the outer surface of the laminate between the first band portion and the second band portion and the outer surface of the first resin sealing body, shown in the above cross-sectional photograph. The thickness of the band portion may be a maximum value of thicknesses of the band portion shown in the above cross-sectional photograph.

The second resin sealing body 1220 may be a softer material than the first resin sealing body 1210. That is, the second resin sealing body 1220 may be less resistant to elastic deformation than the first resin sealing body 1210. Accordingly, the elastic modulus (or Young's modulus) of the second resin sealing body 1220 may be smaller than the elastic modulus of the first resin sealing body 1210.

The second resin sealing body 1220 may cover the first resin sealing body 1210 and expose a portion of the first external electrode 300 and a portion of the second external electrode 400.

The second resin sealing body 1220 may cover a portion of the first band portion 303 that is not covered by the first resin sealing body 1210, and a portion of the second band portion 403 that is not covered by the first resin sealing body 1210. That is, the second resin sealing body 1220 may cover the first band portion 303 between the first edge portion 305 and the first resin sealing body 1210. Additionally, the second resin sealing body 1220 may cover the second band portion 403 between the second edge portion 405 and the first resin sealing body 1210.

For example, the first band portion 303 may be divided into a portion covered by the first resin sealing body 1210, a portion covered by the second resin sealing body 1220, and a remaining portion. Additionally, the second band portion 403 may be divided into a portion covered by the first resin scaling body 1210, a portion covered by the second resin sealing body 1220, and a remaining portion.

Meanwhile, the second resin sealing body 1220 may expose the first connection portion 301 of the first external electrode 300 and the second connection portion 401 of the second external electrode 400. That is, the second resin sealing body 1220 may not be disposed on the first connection portion 301 and the second connection portion 401.

For example, the second resin sealing body 1220 may include a polyimide resin, a polyimide silicone resin, a silicone resin, a polyamide resin, rubber, a polyurethane resin, or a combination thereof.

An elastic modulus of the second resin sealing body 1220 may be higher than 0 MPa and less than or equal to 0.15 MPa. If the elastic modulus of the second resin sealing body 1220 exceeds 0.15 MPa, hardness may increase, reducing an effect of absorbing external shock.

The elastic modulus of the second resin sealing body 1220 may be measured by a well-known method in the art. For example, the second resin sealing body may be peeled off from the all-solid-state battery, a sample with dimensions of 10 mm×2 mm×4 mm may be cut, and the elastic modulus may be measured while increasing the temperature from 30° C. at a rate of 3° C./minute by using a dynamic mechanical analyzer (DMA) (RSA-G2 available from TA Instruments).

A tensile strength of the second resin sealing body 1220 may be 13 MPa or more and 20 MPa or less. If the tensile strength of the second resin sealing body 1220 is less than 13 MPa, ductility may increase, making it easier to be deformed by external shock, and if the tensile strength exceeds 20 MPa, hardness may increase, reducing the effect of absorbing external shock.

The tensile strength of the second resin sealing body 1220 may be measured by a well-known method in the art. For example, the second resin sealing body may be peeled off from the all-solid-state battery, a sample with dimensions of 10 mm×2 mm×4 mm may be cut, and the tensile strength may be measured while increasing the temperature from 30° C. at a rate of 3° C./minute by using a dynamic mechanical analyzer (DMA) (RSA-G2 available from TA Instruments).

A thickness of the second resin sealing body 1220 may be 1 μm or more and 1 mm or less. If the thickness of the second resin sealing body 1220 is less than 1 μm, it may be difficult to expect the effect of preventing moisture penetration and absorbing external shock, and if the thickness exceeds 1 mm, the overall packaging thickness of the all-solid-state battery becomes larger than necessary, which may be disadvantageous in terms of energy density.

Meanwhile, the thickness of the second resin sealing body 1220 may be 10 μm or more and 500 μm or less.

Here, the thickness of the second resin scaling body is measured based on a scanning electron microscope (SEM) photograph at 10,000 magnification of a cross section taken along the length direction (L-axis direction) and the thickness direction (T-axis direction) at the central portion of the all-solid-state battery 1000 in the width direction (W-axis direction). The thickness of the second resin sealing body may be a maximum value of thicknesses of the second resin sealing body measured in the area between the first band portion and the second band portion shown in the above cross-sectional photograph.

As described above, the elastic modulus of the first resin sealing body 1210 may be greater than the elastic modulus of the second resin sealing body 1220. That is, the first resin sealing body 1210 is a harder material than the second resin sealing body 1220, and therefore may undergo less elastic deformation.

When the all-solid-state battery 1000 is operated, the structures of the positive electrode layer 130 and the negative electrode layer 150 may change, causing the all-solid-state battery 1000 to expand. In this case, the exposed surface, that is, the outer surface, of the laminate 100 may expand mainly. According to the present embodiment, the first resin sealing body 1210 made of a material with a relatively large elastic modulus, that is, a hard material, is in contact with the outer surface of the laminate 100, making it possible to suppress the expansion of the laminate 100 and to prevent moisture infiltration by preventing formation of cracks.

In addition, the second resin sealing body 1220 made of a material with a relatively small elastic modulus, that is, a soft material, covers the first resin sealing body 1210, making it possible to protect the all-solid-state battery 1000 by absorbing externally applied shocks.

In this way, according to the present embodiment, the first resin sealing body 1210 and the second resin sealing body 1220 having different elastic moduli are used together to suppress expansion of the laminate 100 and absorb external shocks, thereby improving the performance of the all-solid-state battery.

Unlike the present embodiment, if the laminate 100 is covered with only the second resin sealing body 1220 without the first resin sealing body 1210, the effect of preventing crack formation may be insufficient because the second resin sealing body 1220 expands with the laminate 100 when the laminate 100 expands. On the other hand, if the laminate 100 is covered only with the first resin sealing body 1210 without the second resin sealing body 1220, the effect of absorbing external shocks may be insufficient.

Meanwhile, the second resin sealing body 1220 may be made of a highly moisture-resistant material. For example, the second resin sealing body 1220 may be made of a material having a water vapor transfer rate (WVTR) of 1 g/m²/day or less. As another example, the second resin sealing body 1220 may be made of a material having a moisture absorption rate of less than 0.1 measured after 24 hours at a temperature of 85° C. and a relative humidity of 85% RH. Therefore, in this case, the effect of preventing moisture penetration may become even greater.

FIG. 6 is a schematic cross-sectional view showing an all-solid-state battery according to another embodiment.

Referring to FIG. 6, an all-solid-state battery 2000 includes an all-solid-state battery element 1100 and a resin sealing body 2200.

The resin sealing body 2200 may partially cover the all-solid-state battery element 1100. The resin sealing body 2200 may expose a portion of the first external electrode 300 and a portion of the second external electrode 400 of the all-solid-state battery element 1100.

The resin sealing body 2200 may include a first resin sealing body 2210 and a second resin sealing body 2220.

The elastic modulus of the first resin sealing body 2210 may be greater than the elastic modulus of the second resin sealing body 2220. The first resin sealing body 2210 may be a harder material than the second resin sealing body 2220.

The first resin sealing body 2210 may cover the outer surface of the laminate 100.

For example, the first resin sealing body 2210 may cover a portion of the third surface S3, a portion of the fourth surface S4, a portion of the fifth surface S5, and a portion of the sixth surface S6 of the laminate 100.

Additionally, the first resin sealing body 2210 may be in contact with the first band portion 303 and the second band portion 403. That is, the first resin sealing body 2210 may be in contact with an end of the first band portion 303 close to the central portion of the laminate 100 in the length direction (L-axis direction). Additionally, the first resin sealing body 2210 may be in contact with an end of the second band portion 403 close to the central portion of the laminate 100 in the length direction (L-axis direction).

Therefore, the first resin sealing body 2210 may cover the outer surface of the laminate 100 while being in contact with the first band portion 303 and the second band portion 403, respectively.

Meanwhile, the thickness of the first resin sealing body 2210 may be smaller than the thickness of the first band portion 303 and may be smaller than the thickness of the second band portion 403.

Here, the thickness of the first resin sealing body and the thickness of the band portion are measured based on a scanning electron microscope (SEM) photograph at 10,000 magnification of a cross section in the length direction (L-axis direction) and the thickness direction (T-axis direction) at the central portion of the all-solid-state battery 2000 in the width direction (W-axis direction). The thickness of the first resin sealing body may be a maximum value of lengths of line segments parallel to the thickness direction (T-axis direction) and connecting the outer surface of the laminate between the first band portion and the second band portion and the outer surface of the first resin sealing body, shown in the above cross-sectional photograph. The thickness of the band portion may be a maximum value of thicknesses of the band portion shown in the above cross-sectional photograph.

Other material properties of the first resin sealing body 2210, not described above, may refer to those of the first resin sealing body 1210 described with reference to the embodiment shown in FIGS. 1-5, and other material properties of the second resin sealing body 2220, not described above, may refer to those of the second resin sealing body 1220 described with reference to the embodiment shown in FIGS. 1-5.

The other components excluding the above are the same as those of the all-solid-state battery shown in FIG. 1, so redundant descriptions thereof will be omitted.

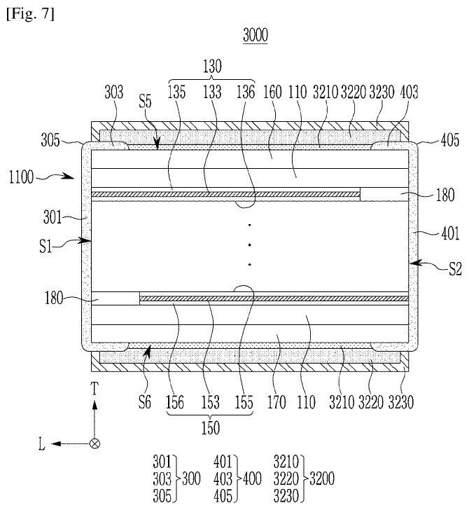

FIG. 7 is a schematic cross-sectional view showing an all-solid-state battery according to yet another embodiment.

Referring to FIG. 7, an all-solid-state battery 3000 includes an all-solid-state battery element 1100 and a resin sealing body 3200.

The resin sealing body 3200 may partially cover the all-solid-state battery element 1100. The resin sealing body 3200 may expose a portion of the first external electrode 300 and a portion of the second external electrode 400 of the all-solid-state battery element 1100.

The resin sealing body 3200 may include a first resin sealing body 3210, a second resin sealing body 3220, and a third resin sealing body 3230.

The elastic modulus of the first resin sealing body 3210 may be greater than the elastic modulus of the second resin sealing body 3220. Additionally, the elastic modulus of the third resin sealing body 3230 may be greater than the elastic modulus of the second resin sealing body 3220. That is, the first resin sealing body 3210 and the third resin sealing body 3230 may be a harder material than the second resin sealing body 3220. The first resin sealing body 3210 and the third resin sealing body 3230 may be made of the same material, but the present embodiment is not limited thereto.

The first resin sealing body 3210 may cover the outer surface of the laminate 100.

For example, the first resin sealing body 3210 may cover a portion of the third surface S3, a portion of the fourth surface S4, a portion of the fifth surface S5, and a portion of the sixth surface S6 of the laminate 100.

Additionally, the first resin sealing body 3210 may be in contact with the first band portion 303 and the second band portion 403. That is, the first resin sealing body 3210 may be in contact with an end of the first band portion 303 close to the central portion of the laminate 100 in the length direction (L-axis direction). Additionally, the first resin sealing body 3210 may be in contact with an end of the second band portion 403 close to the central portion of the laminate 100 in the length direction (L-axis direction).

Therefore, the first resin sealing body 3210 may cover the outer surface of the laminate 100 while being in contact with the first band portion 303 and the second band portion 403, respectively.

Additionally, the thickness of the first resin sealing body 3210 may be smaller than the thickness of the first band portion 303, and the thickness of the first resin sealing body 3210 may be smaller than the thickness of the second band portion 403.

Here, the thickness of the first resin sealing body and the thickness of the band portion are measured based on a scanning electron microscope (SEM) photograph at 10,000 magnification of a cross section in the length direction (L-axis direction) and the thickness direction (T-axis direction) at the central portion of the all-solid-state battery 3000 in the width direction (W-axis direction). The thickness of the first resin sealing body may be a maximum value of lengths of line segments parallel to the thickness direction (T-axis direction) and connecting the outer surface of the laminate between the first band portion and the second band portion and the outer surface of the first resin sealing body, shown in the above cross-sectional photograph. The thickness of the band portion may be a maximum value of thicknesses of the band portion shown in the above cross-sectional photograph.

The second resin sealing body 3220 may cover the first resin sealing body 3210. The second resin sealing body 3220 may be a softer material than the first resin sealing body 3210.

Additionally, the second resin sealing body 3220 may cover a portion of the first band portion 303 and a portion of the second band portion 403.

An area from an end of the first band portion 303 close to a central portion of the laminate 100 in the length direction (L-axis direction) to a point spaced apart from the first edge portion 305 may be covered by the second resin sealing body 3220. That is, the second resin sealing body 3220 may not be disposed on the first edge portion 305 of the first external electrode 300. In addition, an area from an end of the second band portion 403 close to the central portion of the laminate 100 in the length direction (L-axis direction) to a point spaced apart from the second edge portion 405 may be covered by the second resin sealing body 3220. That is, the second resin sealing body 3220 may not be disposed on the second edge portion 405 of the second external electrode 400.

The third resin sealing body 3230 may cover the second resin sealing body 3220 and cxpose a portion of the first external electrode 300 and a portion of the second external electrode 400. The third resin sealing body 3230 may be a harder material than the second resin sealing body 3220.

The third resin sealing body 3230 may cover a portion of the first band portion 303 that is not covered by the second resin sealing body 3220, and a portion of the second band portion 403 that is not covered by the second resin sealing body 3220. That is, the third resin sealing body 3230 may cover the first band portion 303 between the first edge portion 305 and the second resin sealing body 3220. Additionally, the third resin sealing body 3230 may cover the second band portion 403 between the second edge portion 405 and the second resin sealing body 3220. The third resin sealing body 3230 may not be disposed on the first edge portion 305 and the second edge portion 405.

For example, the first band portion 303 may be divided into a portion covered by the second resin sealing body 3220, a portion covered by the third resin sealing body 3230, and a remaining portion. Additionally, the second band portion 403 may be divided into a portion covered by the second resin sealing body 3220, a portion covered by the third resin sealing body 3230, and a remaining portion.

Other material properties of the first resin sealing body 3210 and the third resin sealing body 3230, not described above, may refer to those of the first resin sealing body 1210 described with reference to the embodiment shown in FIGS. 1-5, and other material properties of the second resin sealing body 3220, not described above, may refer to those of the second resin sealing body 1220 described with reference to the embodiment shown in FIGS. 1-5.

The other components excluding the above are the same as those of the all-solid-state battery shown in FIG. 1, so redundant descriptions thereof will be omitted.

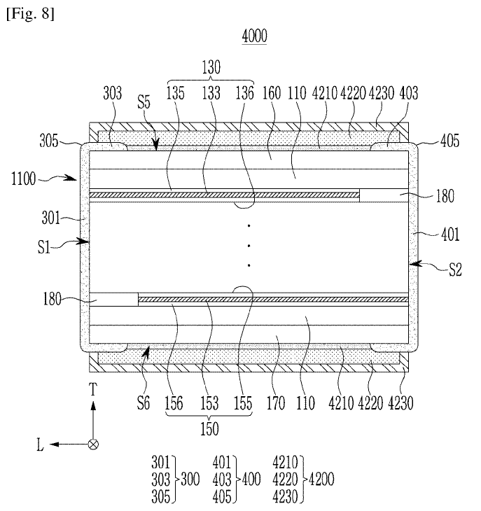

FIG. 8 is a schematic cross-sectional view showing an all-solid-state battery according to yet another embodiment.

Referring to FIG. 8, an all-solid-state battery 4000 includes an all-solid-state battery element 1100 and a resin sealing body 4200.

The resin sealing body 4200 may partially cover the all-solid-state battery element 1100. The resin sealing body 4200 may expose a portion of the first external electrode 300 and a portion of the second external electrode 400 of the all-solid-state battery element 1100.

The resin sealing body 4200 may include a first resin sealing body 4210, a second resin sealing body 4220, and a third resin sealing body 4230.

The elastic modulus of the first resin sealing body 4210 may be smaller than the elastic modulus of the second resin sealing body 4220. Additionally, the elastic modulus of the third resin sealing body 4230 may be smaller than the elastic modulus of the second resin scaling body 4220. That is, the first resin scaling body 4210 and the third resin sealing body 4230 may be a softer material than the second resin sealing body 4220. The first resin sealing body 4210 and the third resin sealing body 4230 may be made of the same material, but the present embodiment is not limited thereto.

The first resin sealing body 4210 may cover the outer surface of the laminate 100.

For example, the first resin sealing body 4210 may cover a portion of the third surface S3, a portion of the fourth surface S4, a portion of the fifth surface S5, and a portion of the sixth surface S6 of the laminate 100.

Additionally, the first resin sealing body 4210 may be in contact with the first band portion 303 and the second band portion 403. That is, the first resin sealing body 4210 may be in contact with an end of the first band portion 303 close to the central portion of the laminate 100 in the length direction (L-axis direction). Additionally, the first resin sealing body 4210 may be in contact with an end of the second band portion 403 close to the central portion of the laminate 100 in the length direction (L-axis direction).

Therefore, the first resin sealing body 4210 may cover the outer surface of the laminate 100 while being in contact with the first band portion 303 and the second band portion 403.

Additionally, the thickness of the first resin sealing body 4210 may be smaller than the thickness of the first band portion 303, and the thickness of the first resin sealing body 4210 may be smaller than the thickness of the second band portion 403.

Here, the thickness of the first resin sealing body and the thickness of the band portion are measured based on a scanning electron microscope (SEM) photograph at 10,000 magnification of a cross section in the length direction (L-axis direction) and the thickness direction (T-axis direction) at the central portion of the all-solid-state battery 4000 in the width direction (W-axis direction). The thickness of the first resin sealing body may be a maximum value of lengths of line segments parallel to the thickness direction (T-axis direction) and connecting the outer surface of the laminate between the first band portion and the second band portion and the outer surface of the first resin sealing body, shown in the above cross-sectional photograph. The thickness of the band portion may be a maximum value of thicknesses of the band portion shown in the above cross-sectional photograph.

The second resin sealing body 4220 may cover the first resin sealing body 4210. The second resin sealing body 4220 may be a harder material than the first resin sealing body 4210.

Additionally, the second resin sealing body 4220 may cover a portion of the first band portion 303 and a portion of the second band portion 403.

An area from an end of the first band portion 303 close to a central portion of the laminate 100 in the length direction (L-axis direction) to a point spaced apart from the first edge portion 305 may be covered by the second resin sealing body 4220. That is, the second resin sealing body 4220 may not be disposed on the first edge portion 305. In addition, an area from an end of the second band portion 403 close to the central portion of the laminate 100 in the length direction (L-axis direction) to a point spaced apart from the second edge portion 405 may be covered by the second resin sealing body 4220. That is, the second resin sealing body 4220 may not be disposed on the second edge portion 405.

The third resin sealing body 4230 may cover the second resin sealing body 4220 and expose a portion of the first external electrode 300 and a portion of the second external electrode 400. The third resin sealing body 4230 may be a softer material than the second resin sealing body 4220.

The third resin sealing body 4230 may cover a portion of the first band portion 303 that is not covered by the second resin sealing body 4220, and a portion of the second band portion 403 that is not covered by the second resin sealing body 4220. That is, the third resin sealing body 4230 may cover the first band portion 303 between the first edge portion 305 and the second resin sealing body 4220. Additionally, the third resin sealing body 4230 may cover the second band portion 403 between the second edge portion 405 and the second resin sealing body 4220. The third resin sealing body 4230 may not be disposed on the first edge portion 305 and the second edge portion 405.

For example, the first band portion 303 may be divided into a portion covered by the second resin sealing body 4220, a portion covered by the third resin sealing body 4230, and a remaining portion. Additionally, the second band portion 403 may be divided into a portion covered by the second resin sealing body 4220, a portion covered by the third resin sealing body 4230, and a remaining portion.

According to the present embodiment, the first resin sealing body 4210 made of a material having a relatively small elastic modulus, that is, a soft material, is in contact with the outer surface of the laminate 100, so the first resin sealing body 4210 may expand together with the laminate 100 when the all-solid-state battery 4000 is operated. However, the second resin sealing body 4220 made of a material having a relatively large elastic modulus, that is, a hard material, covers the first resin sealing body 4210, making it possible to suppress expansion of the laminate 100.

Other material properties of the first resin sealing body 4210 and the third resin sealing body 4230, not described above, may refer to those of the second resin sealing body 1220 described with reference to the embodiment shown in FIGS. 1-5, and other material properties of the second resin sealing body 4220, not described above, may refer to those of the first resin sealing body 1210 described with reference to the embodiment shown in FIGS. 1-5.

The other components excluding the above are the same as those of the all-solid-state battery shown in FIG. 1, so redundant descriptions thereof will be omitted.

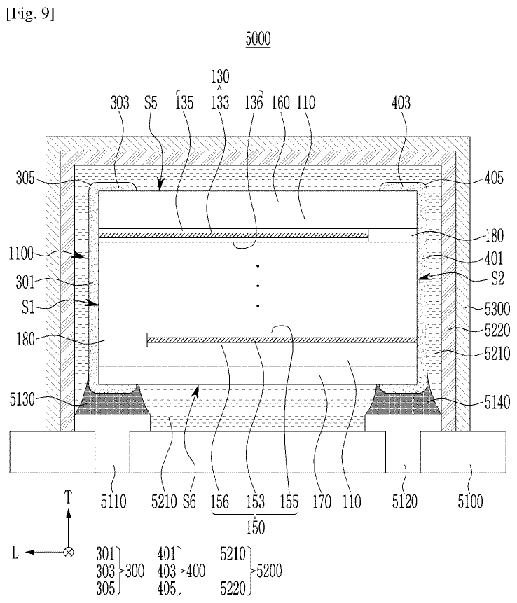

FIG. 9 is a schematic cross-sectional view showing an all-solid-state battery according to still yet another embodiment.

Referring to FIG. 9, an all-solid-state battery 5000 includes an all-solid-state battery element 1100, a substrate 5100, a resin sealing body 5200, and an outer casing 5300.

The all-solid-state battery element 1100 includes a laminate 100, a first external electrode 300, and a second external electrode 400.

The all-solid-state battery element 1100 may be mounted on the substrate 5100. The substrate 5100 is a circuit substrate, may be a multi-layer circuit substrate, a single-layer double-sided printed substrate, or the like, with no limitations of particular types.

The substrate 5100 may include a first electrode pad 5110 and a second electrode pad 5120.

The first electrode pad 5110 may be electrically connected to the first external electrode 300 of the all-solid-state battery element 1100. For example, the first external electrode 300 may be electrically connected to the first electrode pad 5110 via a first conductive bonding member 5130. The first conductive bonding member may include solder, for example.

The second electrode pad 5120 may be electrically connected to the second external electrode 400 of the all-solid-state battery element 1100. For example, the second external electrode 400 may be electrically connected to the second electrode pad 5120 via a second conductive bonding member 5140. The second conductive bonding member may include solder, for example.

The resin sealing body 5200 may include a first resin sealing body 5210 and a second resin sealing body 5220.

The elastic modulus of the first resin sealing body 5210 may be greater than the elastic modulus of the second resin sealing body 5220. That is, the first resin sealing body 5210 may be made of a material harder than the second resin sealing body 5220.

The first resin sealing body 5210 may cover at least a portion of the all-solid-state battery element 1100 and may be in contact with the substrate 5100.

For example, the first resin sealing body 5210 may cover entirely the all-solid-state battery 1100 except for the region between the all-solid-state battery 1100 and the substrate 5100 that is occupied by the first electrode pad 5110, the second electrode pad 5120, the first conductive bonding member 5130, and the second conductive bonding member 5140.

The second resin sealing body 5220 may cover the first resin sealing body 5210 and may be in contact with the substrate 5100. The second resin sealing body 5220 may be made of a softer material than the first resin sealing body 5210.

The outer casing 5300 may cover the second resin scaling body 5220 and may be in contact with the substrate 5100.

The outer casing 5300 may be made of metal or alloy. For example, the outer casing 5300 may include aluminum, aluminum alloy, steel, stainless steel, or a combination thereof.

The outer casing 5300 may be made by processing a plate or by joining plates, but the present embodiment is not limited thereto.

Other material properties of the first resin sealing body 5210, not described above, may refer to those of the first resin sealing body 1210 described with reference to the embodiment shown in FIGS. 1-5, and other material properties of the second resin sealing body 5220, not described above, may refer to those of the second resin sealing body 1220 described with reference to the embodiment shown in FIGS. 1-5.

The other components excluding the above are the same as those of the all-solid-state battery shown in FIG. 1, so redundant descriptions thereof will be omitted.

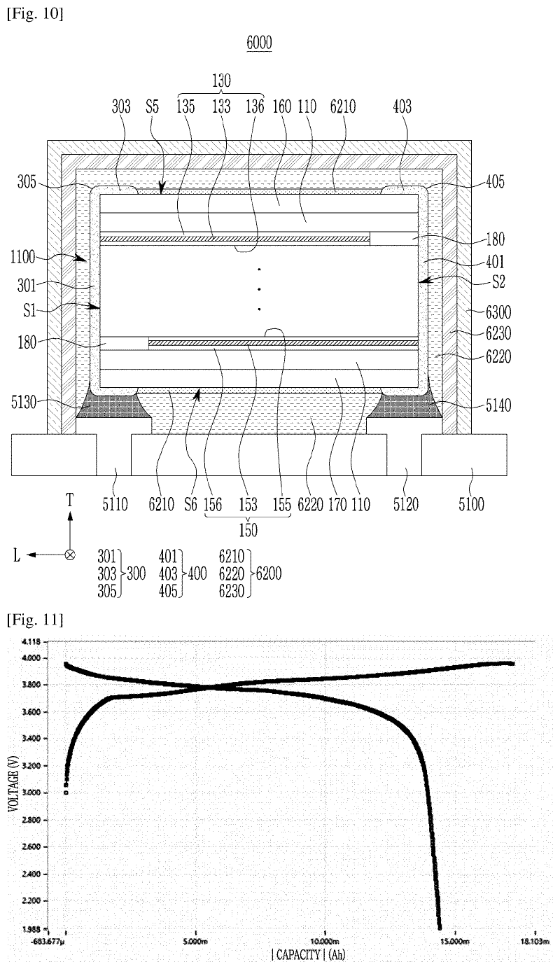

FIG. 10 is a schematic cross-sectional view showing an all-solid-state battery according to yet another embodiment.

Referring to FIG. 10, an all-solid-state battery 6000 includes an all-solid-state battery element 1100, a substrate 5100, a resin sealing body 6200, and an outer casing 6300.

The all-solid-state battery element 1100 includes a laminate 100, a first external electrode 300, and a second external electrode 400.

The all-solid-state battery element 1100 may be mounted on the substrate 5100.

The substrate 5100 may include a first electrode pad 5110 and a second electrode pad 5120.

The first electrode pad 5110 may be electrically connected to the first external electrode 300 of the all-solid-state battery element 1100. For example, the first external electrode 300 may be electrically connected to the first electrode pad 5110 via a first conductive bonding member 5130. The first conductive bonding member may include solder, for example.

The second electrode pad 5120 may be electrically connected to the second external electrode 400 of the all-solid-state battery element 1100. For example, the second external electrode 400 may be electrically connected to the second electrode pad 5120 via a second conductive bonding member 5140. The second conductive bonding member may include solder, for example.

The resin sealing body 6200 may include a first resin sealing body 6210, a second resin sealing body 6220, and a third resin sealing body 6230.

The elastic modulus of the first resin sealing body 6210 may be smaller than the elastic modulus of the second resin sealing body 6220. Additionally, the elastic modulus of the third resin scaling body 6230 may be smaller than the clastic modulus of the second resin sealing body 6220. That is, the first resin sealing body 6210 and the third resin sealing body 6230 may be a softer material than the second resin sealing body 6220. The first resin sealing body 6210 and the third resin sealing body 6230 may be made of the same material, but the present embodiment is not limited thereto.

The first resin sealing body 6210 may cover the outer surface of the laminate 100.

For example, the first resin sealing body 6210 may cover a portion of the third surface S3, a portion of the fourth surface S4, a portion of the fifth surface S5, and a portion of the sixth surface S6 of the laminate 100.

Additionally, the first resin sealing body 6210 may be in contact with the first band portion 303 and the second band portion 403. That is, the first resin sealing body 6210 may be in contact with an end of the first band portion 303 close to the central portion of the laminate 100 in the length direction (L-axis direction). Additionally, the first resin sealing body 6210 may be in contact with an end of the second band portion 403 close to the central portion of the laminate 100 in the length direction (L-axis direction).

Therefore, the first resin sealing body 6210 may cover the outer surface of the laminate 100 while being in contact with the first band portion 303 and the second band portion 403.

Additionally, the thickness of the first resin sealing body 6210 may be smaller than the thickness of the first band portion 303, and the thickness of the first resin sealing body 6210 may be smaller than the thickness of the second band portion 403.

Here, the thickness of the first resin sealing body and the thickness of the band portion are measured based on a scanning electron microscope (SEM) photograph at 10,000 magnification of a cross section taken along the length direction (L-axis direction) and the thickness direction (T-axis direction) at the central portion of the all-solid-state battery 6000 in the width direction (W-axis direction). The thickness of the first resin sealing body may be a maximum value of lengths of line segments parallel to the thickness direction (T-axis direction) and connecting the outer surface of the laminate between the first band portion and the second band portion and the outer surface of the first resin sealing body, shown in the above cross-sectional photograph. The thickness of the band portion may be a maximum value of thicknesses of the band portion shown in the above cross-sectional photograph.

The second resin sealing body 6220 may cover at least a portion of the all-solid-state battery element 1100 and the first resin sealing body 6210, and may be in contact with the substrate 5100. The second resin sealing body 6220 may be a harder material than the first resin sealing body 6210.

For example, the second resin scaling body 6220 may cover entirely the all-solid-state battery 1100 and the first resin sealing body 6210 except for the region between the all-solid-state battery 1100 and first resin sealing body 6210 and the substrate 5100 that is occupied by the first electrode pad 5110, the second electrode pad 5120, the first conductive bonding member 5130, and the second conductive bonding member 5140.

The third resin sealing body 6230 may cover the second resin sealing body 6220 and may be in contact with the substrate 5100. The third resin sealing body 6230 may be a softer material than the second resin sealing body 6220.

The outer casing 6300 may cover the third resin sealing body 6230 and may be in contact with the substrate 5100.

The outer casing 6300 may be made of metal or alloy. For example, the outer case 6300 may include aluminum, aluminum alloy, steel, stainless steel, or a combination thereof.

The outer casing 6300 may be made by processing a plate or by joining plates, but the present embodiment is not limited thereto.

Other material properties of the first resin sealing body 6210 and the third resin sealing body 6230, not described above, may refer to those of the second resin sealing body 1220 described with reference to the embodiment shown in FIGS. 1-5, and other material properties of the second resin sealing body 6220, not described above, may refer to those of the first resin sealing body 1210 described with reference to the embodiment shown in FIGS. 1-5.

The other components excluding the above are the same as those of the all-solid-state battery shown in FIG. 9, so redundant descriptions thereof will be omitted.

### Preparation Example: Manufacture of All-Solid-State Battery

### Example

A plurality of striped positive electrode layers was formed by printing on a solid electrolyte layer (green sheet) in the order of a positive electrode active material layer, a positive electrode current collector, and a positive electrode active material layer, and then a space between the positive electrode layers was filled with an insulating material to form a positive electrode sheet.

A plurality of striped negative electrode layers was formed by printing on a solid electrolyte layer (green sheet) in the order of a negative electrode active material layer, a negative electrode current collector, and a negative electrode active material layer, and then a space between the negative electrode layers was filled with an insulating material to form a negative electrode sheet.

The positive electrode sheet and the negative electrode sheet were alternately stacked to form a green chip.

The green chip was cut to form a laminate.

The laminate was sintered in the range of 400° C. to 550° C. in an air or nitrogen atmosphere.

After applying a conductive paste to a surface of the laminate, the laminate was sequentially maintained in a curing oven at 50° C., 80° C., and 200° C. for 30 minutes, respectively, and then cooled to form an external electrode.

Epoxy resin was applied to cover a portion of the surface of the laminate and a portion of the external electrode and then cured.

An all-solid-state battery was prepared by applying polyimide silicone resin to cover the epoxy resin and then curing the same.

### Comparative Example

A plurality of striped positive electrode layers was formed by printing on a solid electrolyte layer (green sheet) in the order of a positive electrode active material layer, a positive electrode current collector, and a positive electrode active material layer, and then a space between the positive electrode layers was filled with an insulating material to form a positive electrode sheet.

A plurality of striped negative electrode layers was formed by printing on a solid electrolyte layer (green sheet) in the order of a negative electrode active material layer, a negative electrode current collector, and a negative electrode active material layer, and then a space between the negative electrode layers was filled with an insulating material to form a negative electrode sheet.

The positive electrode sheet and the negative electrode sheet were alternately stacked to form a green chip.

The green chip was cut to form a laminate.

The laminate was sintered in the range of 400° C. to 550° C. in an air or nitrogen atmosphere.

A margin portion was disposed on the surface of the sintered laminate.

After applying a conductive paste to a surface of the laminate, the laminate was sequentially maintained in a curing oven at 50° C., 80° C., and 200° C. for 30 minutes, respectively, and then cooled to form an external electrode, thereby preparing an all-solid-state battery.

### Experimental Example: Evaluation of Moisture Resistance of All-Solid-State Batteries

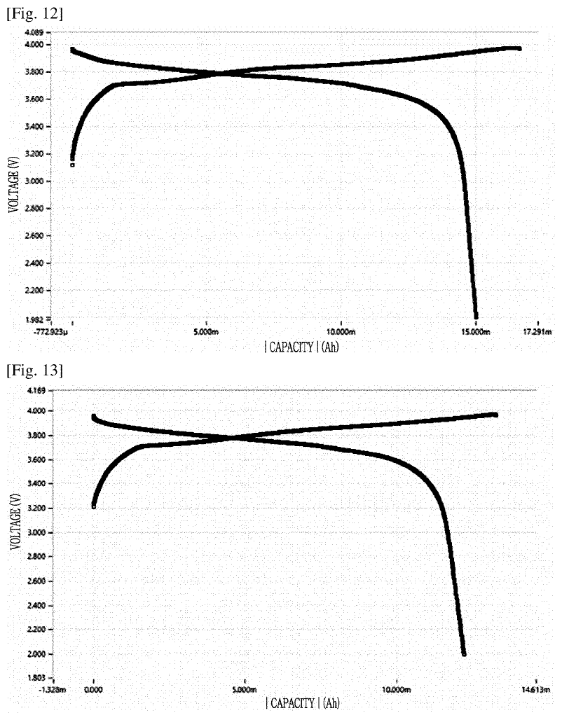

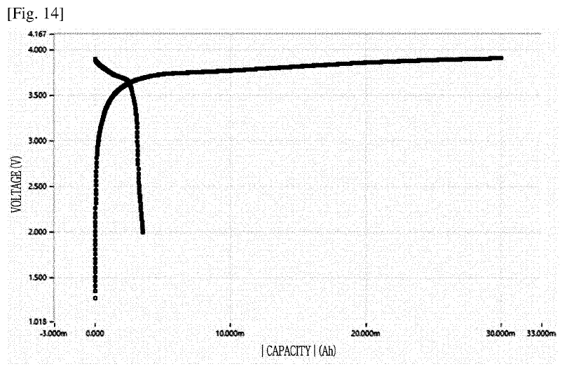

Five pieces of all-solid-state batteries of the Example and the Comparative Example were prepared, respectively. Each representative sample was subjected to an initial charge/discharge test at a temperature of 25° C. and a humidity of 25% and the results are shown in FIGS. 11 and 12, and was subjected to an initial charge/discharge test at a temperature of 25° C. and a humidity of 55% and the results are shown in FIGS. 13 and 14.

Referring to FIGS. 11 and 12, normal discharge capacity variations were observed in both the all-solid-state battery prepared according to the Example and the all-solid-state battery prepared according to the Comparative Example.

On the other hand, referring to FIGS. 13 and 14, the all-solid-state battery prepared according to the Example exhibited a normal discharge capacity variation, whereas the all-solid-state battery prepared according to the Comparative Example exhibited a sharp decrease in discharge capacity. This appears to be because, under conditions where the humidity increased from 25% to 55%, the volume of the all-solid-state battery prepared according to the Comparative Example expanded, cracks occurred, and moisture penetrated.

While this invention has been described in connection with what is presently considered to be practical embodiments, it is to be understood that the invention is not limited to the disclosed embodiments. On the contrary, it is intended to cover various modifications and equivalents included within the spirit and scope of the appended claims.

### DESCRIPTION OF SYMBOLS

1000: all-solid-state battery
1100: all-solid-state battery element
1200: resin sealing body
1210: first resin sealing body
1220 second resin sealing body
100: laminate
110: solid electrolyte layer
130: positive electrode layer
133: positive electrode current collector
135, 136: positive electrode active material layer
150: negative electrode layer
153: negative electrode current collector
155, 156: negative electrode active material layer
160: upper protective layer
170: lower protective layer
180: margin portion
300: first external electrode
400: second external electrode
5100: substrate
5110: first electrode pad
5120: second electrode pad
5130: first conductive bonding member
5140: second conductive bonding member
5300: outer casing

1. An all-solid-state battery comprising:
an all-solid-state battery element comprising:
a laminate comprising a plurality of solid electrolyte layers, a plurality of positive electrode layers, and a plurality of negative electrode layers stacked in a first direction,
a first external electrode disposed outside of the laminate and connected to the plurality of positive electrode layers, and
a second external electrode disposed outside of the laminate and connected to the plurality of negative electrode layers; and
a resin sealing body covering the all-solid-state battery element and exposing a portion of the first external electrode and a portion of the second external electrode,
wherein the resin sealing body includes a first resin sealing body and a second resin sealing body, and
wherein an elastic modulus of the first resin sealing body is different from an clastic modulus of the second resin scaling body.

2. The all-solid-state battery of claim 1,
wherein the resin sealing body exposes an end surface of the first external electrode in a second direction and an end surface of the second external electrode in the second direction, and
wherein the second direction intersects with the first direction.

3. The all-solid-state battery of claim 1,
wherein the first resin sealing body covers an outer surface of the laminate, and
wherein the second resin sealing body covers the first resin sealing body, at least a portion of a remaining portion excluding the portion of the first external electrode, and at least a portion of a remaining portion excluding the portion of the second external electrode.

4. The all-solid-state battery of claim 3,
wherein the first external electrode includes a first band portion disposed on an outer surface of the laminate in the first direction, wherein the second external electrode comprises a second band portion disposed on the outer surface of the laminate in the first direction, and
wherein both ends of the first resin sealing body in the second direction are in contact with the first band portion and the second band portion, respectively.

5. The all-solid-state battery of claim 4,
wherein a thickness of the first resin sealing body is smaller than a thickness of the first band portion and a thickness of the second band portion.

6. The all-solid-state battery of claim 3,
wherein the first external electrode includes a first band portion disposed on an outer surface of the laminate in the first direction, wherein the second external electrode includes a second band portion arranged on the outer surface of the laminate in the first direction,
wherein the first resin sealing body covers a portion of the first band portion and a portion of the second band portion, and
wherein the second resin sealing body covers a remaining portion of the first band portion and a remaining portion of the second band portion.

7. The all-solid-state battery of claim 6,
wherein a thickness of the first resin sealing body is greater than a thickness of the first band portion and greater than a thickness of the second band portion.

8. The all-solid-state battery of claim 1,
wherein the clastic modulus of the first resin scaling body is greater than the elastic modulus of the second resin sealing body, and the second resin sealing body covers the first resin sealing body.

9. The all-solid-state battery of claim 1,
wherein the elastic modulus of the first resin sealing body is smaller than the elastic modulus of the second resin sealing body, and the second resin sealing body covers the first resin sealing body.

10. The all-solid-state battery of claim 1,
wherein the first resin sealing body includes a phenolic epoxy resin, a phenol resin, a novolac epoxy resin, an Ortho-Cresol resin, an acryl resin, or a combination thereof.

11. The all-solid-state battery of claim 1,
wherein the second resin sealing body includes a polyimide resin, a polyimide silicone resin, a silicone resin, a polyamide resin, rubber, a polyurethane resin, or a combination thereof.

12. An all-solid-state battery comprising:
an all-solid-state battery element comprising:
a laminate comprising a plurality of solid electrolyte layers, a plurality of positive electrode layers, and a plurality of negative electrode layers stacked in a first direction,
a first external electrode disposed outside of the laminate and connected to the plurality of positive electrode layers, and a second external electrode disposed outside of the laminate and connected to the plurality of negative electrode layers; and
a resin sealing body covering the all-solid-state battery element and exposing a portion of the first external electrode and a portion of the second external electrode,
wherein the resin sealing body includes a first resin sealing body, a second resin sealing body, and a third resin sealing body stacked in the first direction.

13. The all-solid-state battery of claim 12,
wherein an elastic modulus of the first resin sealing body is greater than an elastic modulus of the second resin sealing body, and
wherein an elastic modulus of the third resin sealing body is greater than the clastic modulus of the second resin scaling body.

14. The all-solid-state battery of claim 13,
wherein the first external electrode includes a first band portion disposed on an outer surface of the laminate in the first direction, wherein the second external electrode includes a second band portion arranged on the outer surface of the laminate in the first direction,
wherein the first resin sealing body covers the outer surface of the laminate and is in contact with the first band portion and the second band portion,
wherein the second resin sealing body covers the first resin sealing body and is in contact with the first band portion and the second band portion,
wherein the third resin sealing body covers the second resin sealing body and exposes an end surface of the first external electrode in a second direction and an end surface of the second external electrode in the second direction, and wherein the second direction intersects with the first direction.

15. The all-solid-state battery of claim 14,
wherein the first resin sealing body is disposed between the first band portion and the second band portion, and
wherein a thickness of the first resin sealing body is smaller than a thickness of the first band portion and smaller than a thickness of the second band portion.

16. The all-solid-state battery of claim 12, wherein:
an elastic modulus of the first resin sealing body is smaller than an elastic modulus of the second resin sealing body, and
wherein an elastic modulus of the third resin sealing body is smaller than the elastic modulus of the second resin sealing body.

17. The all-solid-state battery of claim 16,
wherein the first external electrode includes a first band portion disposed on an outer surface of the laminate in the first direction, wherein the second external electrode includes a second band portion arranged on the outer surface of the laminate in the first direction,
wherein the first resin sealing body covers the outer surface of the laminate and is in contact with the first band portion and the second band portion,
wherein the second resin scaling body covers the first resin scaling body and is in contact with the first band portion and the second band portion,
wherein the third resin sealing body covers the second resin sealing body and exposes an end surface of the first external electrode in a second direction and an end surface of the second external electrode in the second direction, and
wherein the second direction intersects with the first direction.

18. The all-solid-state battery of claim 17,
wherein the first resin sealing body is disposed between the first band portion and the second band portion, and
wherein a thickness of the first resin sealing body is smaller than a thickness of the first band portion and smaller than a thickness of the second band portion.

19. An all-solid-state battery comprising:
an all-solid-state battery element comprising:
a laminate comprising a plurality of solid electrolyte layers, a plurality of positive electrode layers, and a plurality of negative electrode layers stacked in a first direction,
a first external electrode disposed outside of the laminate and connected to the plurality of positive electrode layers, and
a second external electrode disposed outside of the laminate and connected to the plurality of negative electrode layers;
a substrate comprising a first electrode pad connected to the first external electrode of the all-solid-state battery element and a second electrode pad connected to the second external electrode of the all-solid-state battery element;
a resin sealing body that covers the all-solid-state battery element and is in contact with the substrate; and
an outer casing that covers the resin sealing body,
wherein the resin sealing body comprises a first resin sealing body and a second resin sealing body, and
wherein the first resin sealing body covers at least a portion of the all-solid-state battery element,
wherein the second resin sealing body covers the first resin sealing body and is in contact with the substrate, and
wherein an elastic modulus of the first resin sealing body is different from an elastic modulus of the second resin sealing body.

20. The all-solid-state battery of claim 19,
wherein the elastic modulus of the first resin sealing body is greater than the elastic modulus of the second resin sealing body.

21. The all-solid-state battery of claim 19,
wherein the elastic modulus of the first resin sealing body is smaller than the elastic modulus of the second resin sealing body.

22. The all-solid-state battery of claim 21,
wherein the resin sealing body further comprises a third resin sealing body that covers the second resin sealing body and is in contact with the substrate, and
wherein an elastic modulus of the third resin sealing body is smaller than the elastic modulus of the second resin sealing body.

23. The all-solid-state battery of claim 22,
wherein the first resin sealing body covers an outer surface of the laminate,
wherein the first external electrode comprises a first band portion disposed on the outer surface of the laminate in the first direction, wherein the second external electrode includes a second band portion arranged on the outer surface of the laminate in the first direction, and
wherein a thickness of the first resin sealing body is smaller than a thickness of the first band portion and a thickness of the second band portion.

24. The all-solid-state battery of claim 19,
wherein the outer casing comprises a metal or an alloy.

25. The all-solid-state battery of claim 24,
wherein the outer casing comprises aluminum (Al), an aluminum (Al) alloy, steel, stainless steel, or a combination thereof.

26. An all-solid-state battery comprising:
an all-solid-state battery element comprising:
a laminate comprising a plurality of solid electrolyte layers, a plurality of positive electrode layers, and a plurality of negative electrode layers stacked in a first direction,
a first external electrode disposed outside of the laminate and connected to the plurality of positive electrode layers, and a second external electrode disposed outside of the laminate and connected to the plurality of negative electrode layers; and
a resin sealing body extending between the first external electrode and the second external electrode and covering a portion of the first external electrode and a portion of the second external electrode,
wherein the resin sealing body includes a plurality of layers and is spaced apart from the plurality of positive electrode layers and the plurality of negative electrode layers.

27. The all-solid-state battery of claim 26,
wherein the laminate includes a plurality of surfaces,
wherein the first external electrode is disposed on a first surface among the plurality of surfaces to connect to the plurality of positive electrode layers, and the second external electrode is disposed on a second surface among the plurality of surfaces to connect to the plurality of negative electrode layers,
wherein the first surface opposes the second surface, and
wherein among the plurality of surfaces, the resin sealing body covers surfaces other than the first surface and the second surface.

28. The all-solid-state battery of claim 26,
wherein at least two of the plurality of layers of the resin sealing body include different materials.

29. The all-solid-state battery of claim 28,
wherein the at least two of the plurality of layers of the resin sealing body have different elastic moduli.

30. The all-solid-state battery of claim 26,
wherein one of the plurality of layers of the resin sealing body has an elastic modulus greater than an elastic modulus of another of the plurality of layers of the resin sealing body covering the one of the plurality of layers of the resin sealing body.

31. The all-solid-state battery of claim 30,
wherein the elastic modulus of the one of the plurality of layers of the resin sealing body is 100 MPa or more, and the another of the plurality of layers of the resin sealing body is 0.15 MPa or less.

32. The all-solid-state battery of claim 26,
wherein at least two of the plurality of layers of the resin sealing body are in contact with the first external electrode and the second external electrode.

33. An all-solid-state battery comprising:
an all-solid-state battery element comprising:
a laminate comprising a plurality of solid electrolyte layers, a plurality of positive electrode layers, and a plurality of negative electrode layers stacked in a first direction,
a first external electrode disposed outside of the laminate and connected to the plurality of positive electrode layers, and
a second external electrode disposed outside of the laminate and connected to the plurality of negative electrode layers;
a substrate comprising a first electrode pad connected to the first external electrode of the all-solid-state battery element and a second electrode pad connected to the second external electrode of the all-solid-state battery element;
a first resin sealing body that covers the all-solid-state battery element and is disposed between the all-solid-state battery element and the substrate to be in contact with the substrate;
a second resin sealing body that covers the first resin sealing body and is in contact with the substrate; and
an outer casing that covers the second resin sealing body.

34. The all-solid-state battery of claim 33,
wherein an elastic modulus of the first resin sealing body is different from an elastic modulus of the second resin sealing body.

35. The all-solid-state battery of claim 34,
wherein the elastic modulus of the first resin sealing body is greater than the elastic modulus of the second resin sealing body.

36. The all-solid-state battery of claim 33,
wherein the first resin sealing body covers and is in contact with the first external electrode and second external electrode.

37. The all-solid-state battery of claim 36,
wherein the second resin sealing body is spaced apart from the first external electrode and second external electrode.

38. The all-solid-state battery of claim 33,
wherein the second resin sealing body is spaced apart from the laminate.

39. The all-solid-state battery of claim 33,
wherein on the substrate, the first resin sealing body is disposed between the first electrode pad and the second electrode pad and the second resin sealing body is disposed in a region outside the first electrode pad and the second electrode.
